(19) United States
(12) Patent Application Publication
(10) Pub. No.: US 2026/0221075 A1
(43) Pub. Date: Jul. 30, 2026

(54) LOW-COST CONTROL CIRCUITS FOR INDEPENDENT ALTERNATING-INPUT DEVICES

(71) Applicant: Adobe Inc., San Jose, CA (US)

(72) Inventors: Tenell Glen Rhodes, San Jose, CA (US); Gavin Stuart Peter Miller, Los Altos, CA (US); Christine Marie Dierk, San Jose, CA (US); Benjamin Stephen Price, Brooklyn, NY (US); Hendrik Karel Rene Cannoodt, Lochristi (BE); Usman Akbar Jamil, Brooklyn, NY (US); Matthew David LaVoie, Brattleboro, VT (US)

(73) Assignee: Adobe Inc., San Jose, CA (US)

(21) Appl. No.: 19/041,800

(22) Filed: Jan. 30, 2025

(51) Int. Cl. G09G 3/20; G09G 3/32

(52) U.S. Cl. CPC G09G 3/2096; G09G 3/32; G09G 2300/0426; G09G 2310/027; G09G 2310/0286

(57) ABSTRACT

In implementations of techniques and systems for independent alternating-input (“IAI”) devices, a control system includes multiple IAI devices and a logic circuit component. The logic circuit component includes, for example, an analog switch, a d-type latch, a shift register, and an LED driver. The control system provides a first voltage signal (e.g., a bus signal) to a first voltage input of each IAI device. In response to a control signal from the control system, the logic circuit component provides a second voltage signal to a second voltage input of each IAI device. The second voltage signal can include the bus signal or an inverted bus signal. Each IAI device is activated in response to a voltage differential across the voltage inputs. In this way, the quantity of IAI devices for large arrangements (e.g., high-resolution display systems) can be greatly increased by utilizing low-cost logic circuits.

### BACKGROUND

The perceived quality of a display device, including flexible displays, is generally dependent on pixel density and resolution. Flexible displays include devices suitable for attachment to fabric, curved walls, and other surfaces. Higher pixel resolution and density, however, often involve an increase in circuitry components, thereby also increasing the overall cost of the display device. The expense of display elements driven by alternating current (AC) also increases due to circuitry used to handle negative currents. Consequently, conventional display technologies for large-area surfaces with a high resolution are expensive due to a high cost per pixel.

### SUMMARY

Techniques and systems for low-cost control circuits for independent alternating-input (“IAI”) devices are described. The techniques described use quad analog switches, multiple-bit d-type latches, shift registers, or LED drivers to significantly lower the cost per IAI device (e.g., each pixel or petal). In one example implementation, the IAI devices are used for binary and grayscale non-emissive display systems.

In one example, a control system for multiple IAI devices includes a series of analog switches. One voltage input of each IAI device is connected to a bus line. The other voltage input of each IAI device is selectively connected to a shared column line through an output terminal of an analog switch. A corresponding row line for each row of IAI devices controls a selective connection of the other voltage input. Each IAI device is passively activated when a voltage differential is present across the voltage inputs. A column state is set for each row of IAI devices while the row line is not activated. The row lines are configured for individual activation in quick succession because the IAI devices do not maintain a state while a corresponding row line is inactive, e.g., not activated.

In another example involving a passive-matrix control system, both voltage inputs of the IAI devices are selectively connected to a corresponding column line and the bus line via an analog switch. Another implementation of the control systems with analog switches supports an active-matrix control system by adding a capacitor in parallel between the voltage inputs of each IAI device so that the IAI devices maintain a previous state when the row line is inactive, e.g., not activated.

In a further example, a control system for multiple IAI devices includes a series of d-type latches. One voltage input of each IAI device is connected to a bus line. The other voltage input of each IAI device is connected to a latch output terminal of a d-type latch. Each latch input terminal is connected to a column line. Each latch output terminal copies a state of a corresponding latch input terminal when the row line is activated. Each latch output terminal maintains its previous state when the row line is not activated. Each IAI device is activated when a voltage differential is present across the voltage inputs. A column state is set for each row of IAI devices while the row line is not activated. Because either voltage input is not open circuit, the IAI devices are driven to an activated or deactivated state.

In another example, a control system for multiple IAI devices includes a series of shift registers. One voltage input of each IAI device is connected to a bus line. The other voltage input of each IAI device is connected to an output of a corresponding register. The shift registers are serially chained, sharing control, data, and clock lines. Data is shifted into the register outputs while the control line is low. When the control line is high, the data in the registers appears at the output terminals, with each output terminal maintaining a previous state. Each IAI device is activated when a voltage differential is present across the voltage inputs. Because either voltage input is not open circuit, the IAI devices are driven to an activated or deactivated state.

In another example, a control system for multiple IAI devices includes a series of LED drivers. The LED drivers are serially chained and data addressed to a corresponding IAI device are stored by each LED driver. The LED drivers generate first and second voltage signals for corresponding voltage inputs of IAI devices. Each IAI device is activated when a voltage differential is present across the first and second voltage signals.

This Summary introduces a simplified selection of concepts described below in the Detailed Description. As such, this Summary is not intended to identify essential features of the claimed subject matter or to aid in determining its scope.

### BRIEF DESCRIPTION OF THE DRAWINGS

The detailed description is described with reference to the accompanying figures. Entities represented in the figures indicate one or more entities, and thus, reference is made interchangeably to single or plural forms of the entities in the discussion.

FIG. 1 illustrates an environment in an example implementation that is operable to employ low-cost control circuits for independent alternating-input (“IAI”) devices as described herein.

FIG. 2 illustrates an example system employing low-cost control circuits for IAI devices as described herein.

FIG. 3 is a diagram depicting example voltage signals provided by low-cost control circuits for IAI devices.

FIGS. 4A, 4B, 4C, and 4D are diagrams depicting examples of a passive-matrix control system to provide low-cost control circuits for IAI devices.

FIGS. 5A, 5B, 5C, and 5D are diagrams depicting examples of an active-matrix control system to provide low-cost control circuits for IAI devices.

FIGS. 6A and 6B are diagrams depicting examples of a direct-drive control system to provide low-cost control circuits for IAI devices.

FIGS. 7A, 7B, 7C, 7D, and 7E are diagrams depicting additional examples of a direct-drive control system to provide low-cost control circuits for IAI devices.

FIG. 8 illustrates an example of a computing device according to aspects of the techniques described herein.

### DETAILED DESCRIPTION

### Overview

Module light-diffuser display systems have been developed that can be affixed to surfaces, including surfaces on portable objects (e.g., clothing and textiles) and less portable objects. Light-diffuser display systems generally utilize a low-voltage generated alternating current that rotates in the direction of electrical polarity to power a diffuser component and enable the diffuser component to change from diffuse to transparent. Multiple modular light-diffuser devices can be grouped together and flexibly added (e.g., like sequins) to clothing or fabrics to form patterns, designs, and animations based on the changing states of modular light-diffuser devices. Similarly, the modular light-diffuser devices can be joined to form large-format displays, where each modular light-diffuser device functions as a pixel.

Modular light-diffuser device generally utilizes one or more diffuser components with one or more backing layers or materials positioned under each diffuser component. In one or more implementations, the diffuser component includes a combination of layers made of different materials. For example, the diffuser component can include polyethylene terephthalate (PET) layers, conductive coating layers, and a polymer layer that includes liquid crystal molecules (e.g., a PDLC film layer). When an electrical current is applied, the diffuser component changes from the light-scattering state (e.g., diffuse or partially obscured) to the non-light-scattering state, e.g., transparent or translucent. The configuration of the modular light-diffuser device enables a low-voltage direct current (DC) power source to provide generated alternating current (AC) through the diffuser component (e.g., the PDLC film layer). In this manner, the diffuser component supports safe operation and without rapid deterioration.

Modular light-diffuser devices used in large-format displays are generally limited by how many components (or pixels) can be independently controlled. The displayed graphics, for instance, may depend heavily on pixel density and resolution. An increase in resolution and density includes an associated increase in drive circuitry components and a further increase in the total cost of the display system. IAI display elements are comparatively more expensive because the negative current involves additional circuitry. Many display technologies for large-area surfaces with high resolutions cannot be manufactured because the price per pixel is still cost-prohibitive.

A conventional technique implemented to address these issues utilizes control systems that support independent control of multiple IAI devices via a control device. Controlling multiple devices using a single control device can reduce the weight and expense of light diffuser display systems and other configurations of a multitude of IAI devices. One conventional system includes various direct-drive control circuits for IAI devices, including serial peripheral interface (SPI)-enabled analog switches. Although this conventional approach can support an element-to-component ratio of four-to-one in many applications, the high control component price economically limits the maximum display resolution to about 1,700 pixels, which is far below the number of pixels that support high definition (HD) (e.g., 921,600 pixels or 1280×720 pixels) or 4K (e.g., 8,847,360 pixels or 4096×2160 pixels) displays.

In contrast, low-cost control circuits for IAI devices are described. These techniques for passive-matrix, active-matrix, and direct-drive control schemes involve significantly fewer components at a fraction of the cost. In particular, the described techniques use economical components (e.g., quad analog switches, four-bit d-type latches, and shift registers) that dramatically reduce the cost per IAI device for a given display size or pixel count (e.g., up to three hundred times less).

As illustrated by the foregoing discussion, a variety of terms are used to describe the features and advantages of the described techniques and systems. For example, as used herein, the terms “diffuser component” or “diffuser element” refer to a portion of a modular light-diffuser device that selectively scatters or allows the passage of light. A diffuser element can include a sheet, screen, film, or material layer that can alternate between a non-light-scattering state that allows light to pass through and a light-scattering state that scatters light, thereby preventing at least some light from passing through. The diffuser component can be composed of a material that, in response to electrical stimulation, transitions from a diffused appearance (e.g., in the light-scattering state) to a transparent appearance (e.g., in the non-light-scattering state) or vice-versa. For example, the diffuser element includes a PDLC film that can alternate between a non-light-scattering state and a light-scattering state.

In addition, as used herein, the terms “light-scattering state,” “scattering state,” or “scattered state” refer to a state of an object that scatters light. When an object scatters light, the light directed at the object is refracted at various angles (e.g., making the object appear diffuse or at least partially opaque). When a modular light-diffuser device is in a light-scattering state, the modular light-diffuser device becomes diffuse and blocks or otherwise obscures (at least partially) the view of backing or material layer(s) behind the modular light-diffuser device.

As used herein, a “non-light-scattering state” refers to a state of an object that allows all (or nearly all) light directed at the object to pass through the object without blur or attenuation. When a modular light-diffuser device is in a non-light-scattering state, the modular light-diffuser device becomes transparent and allows the view of backing or material layer(s) behind the modular light-diffuser device.

The following discussion describes an example environment that employs the techniques described herein. Example procedures are also described as performable in the example and other environments. Consequently, the performance of the example procedures is not limited to the example environment, and the example environment is not limited to the performance of the example procedures.

In some aspects, the techniques described herein relate to a control system comprising: an independent alternating-input (“IAI”) device of multiple IAI devices, the IAI device having a first voltage input and a second voltage input, the first voltage input electrically connected to a bus line that provides a first voltage signal to the first voltage input; and an analog switch electrically connected to the IAI device, the analog switch including: an input terminal electrically connected to a column line of the control system; and a switch configured to selectively connect and disconnect the input terminal of the analog switch and the second voltage input of the IAI device based on a control signal of a row line associated with the IAI device; wherein the analog switch is configured to: in a first state of the IAI device, provide a second voltage signal to the second voltage input via the switch; and in a second state of the IAI device, provide the first voltage signal to the second voltage input via the switch.

In some aspects, the techniques described herein relate to a control system wherein: the first voltage signal is a bus signal; the second voltage signal is an inverted bus signal; the first state of the IAI device is an activated state; and the second state of the IAI device is a deactivated state.

In some aspects, the techniques described herein relate to a control system wherein the IAI device is configured to maintain or return to the second state when the switch is open.

In some aspects, the techniques described herein relate to a control system wherein: each row line of multiple row lines of the control system are activated individually and in succession; and the second voltage signal or the first voltage signal is applied to each column line of multiple column lines to set the input terminal when the row line is inactive.

In some aspects, the techniques described herein relate to a control system wherein: the IAI device is a first IAI device and the control system further includes a second IAI device, a third IAI device, and a fourth IAI device; the first voltage input of the first IAI device, the second IAI device, the third IAI device, and the fourth IAI device is directly connected to the bus line; and the analog switch is further electrically connected to the second IAI device, the third IAI device, and the fourth IAI device and further includes: a second input terminal and a fourth input terminal electrically connected to a second column line; a third input terminal electrically connected to the column line; a second switch configured to selectively connect and disconnect the second input terminal and the second voltage input of the second IAI device based on the control signal of the row line associated with the IAI device and the second IAI device; a third switch configured to selectively connect and disconnect the third input terminal and the second voltage input of the third IAI device based on the control signal of a second row line associated with the third IAI device and the fourth IAI device; and a fourth switch configured to selectively connect and disconnect the fourth input terminal and the second voltage input of the fourth IAI device based on the control signal of the second row line.

In some aspects, the techniques described herein relate to a control system wherein: the IAI device is a first IAI device and the control system further includes a second IAI device; the first voltage input of the first IAI device and the second IAI device is selectively connected to the bus line; and the analog switch is electrically connected to the bus line and the second IAI device, the analog switch further includes: a second input terminal and a fourth input terminal electrically connected to the bus line; a second switch configured to selectively connect and disconnect the second input terminal of the analog switch and the first voltage input of the first IAI device based on the control signal; a third input terminal electrically connected to a second column line; and a fourth switch configured to selectively connect and disconnect the fourth input terminal of the analog switch and the first voltage input of the second IAI device based on the control signal.

In some aspects, the techniques described herein relate to a control system wherein: the control system further includes a capacitor connected in parallel between the first voltage input and second voltage input of the IAI device ; and the IAI device is configured to maintain a current state when the switch is open.

In some aspects, the techniques described herein relate to a control system wherein a size of the capacitor is based on a refresh rate of the multiple IAI devices.

In some aspects, the techniques described herein relate to a control system wherein the IAI device is one of a polymer dispersed liquid crystal visual element, a polychromic material visual element, a solenoid, a speaker, or a motor.

In some aspects, the techniques described herein relate to a control system comprising: an independent alternating-input (“IAI”) device of multiple IAI devices, the IAI device having a first voltage input and a second voltage input, the first voltage input electrically connected to a bus line that provides a first voltage signal to the first voltage input; and a d-type latch electrically connected to the IAI device, the d-type latch including: a latch input terminal electrically connected to a column line; and a latch output terminal electrically connected to the second voltage input of the IAI device and configured to copy a state of the latch input terminal based on a control signal of a row line associated with the IAI device, wherein the d-type latch is configured to: in a first state of the IAI device, provide a second voltage signal to the second voltage input via the latch output terminal; and in a second state of the IAI device, provide the first voltage signal to the second voltage input via the latch output terminal.

In some aspects, the techniques described herein relate to a control system wherein the second voltage signal or the first voltage signal is applied to the column line to set a value of the latch input terminal when the row line is inactive.

In some aspects, the techniques described herein relate to a control system wherein: the d-type latch is further electrically connected to at least six additional IAI devices; the first state of the multiple IAI devices is an activated state; the second state of the multiple IAI devices is a deactivated state; and the multiple IAI devices are configured to maintain a current state.

In some aspects, the techniques described herein relate to a control system wherein: the first voltage input of each IAI device is directly connected to the bus line; and the d-type latch is electrically connected to at least eight IAI devices.

In some aspects, the techniques described herein relate to a control system wherein: the first voltage input of each IAI device is selectively connected to the bus line; and the d-type latch further includes: an eighth latch input terminal electrically connected to the bus line; and an eighth latch output terminal electrically connected to the first voltage input of the multiple IAI devices, the eighth latch output terminal configured to copy a state of the eighth latch input terminal based on the control signal of the row line.

In some aspects, the techniques described herein relate to a control system comprising: an independent alternating-input (“IAI”) device of multiple IAI devices, the IAI device having a first voltage input and a second voltage input, the first voltage input electrically connected to a bus line that provides a first voltage signal to the first voltage input; and a shift register electrically connected to the IAI device and including: a register of multiple registers, the register configured to receive data from a data line when a control signal has a first voltage level; and an output terminal of the register electrically connected to the second voltage input of the IAI device, the data appearing at the output terminal when the control signal has a second voltage level, wherein the shift register is configured to: in a first state of the IAI device, provide a second voltage signal to the second voltage input via the output terminal; and in a second state of the IAI device, provide the first voltage signal to the second voltage input via the output terminal.

In some aspects, the techniques described herein relate to a control system wherein the second voltage signal or the first voltage signal is applied via the data line to set a value of the register when the control signal is low.

In some aspects, the techniques described herein relate to a control system wherein the control system further includes multiple shift registers that are serially connected and share the control signal and a clock line.

In some aspects, the techniques described herein relate to a control system wherein: the shift register is further electrically connected to at least six additional IAI devices; the first state of the multiple IAI devices is an activated state; the second state of the multiple IAI devices is a deactivated state; and the multiple IAI devices are configured to maintain a current state.

In some aspects, the techniques described herein relate to a control system wherein: the first voltage input of each IAI device is directly connected to the bus line; and the shift register is electrically connected to at least eight IAI devices.

In some aspects, the techniques described herein relate to a control system wherein: the first voltage input of each IAI device is electrically connected to the bus line via an eighth output terminal of the shift register; and the shift register further includes: an eighth register configured to receive the first voltage signal via the data line when the control signal has the first voltage level; and an eighth output terminal of the register electrically connected to the first voltage input of the multiple IAI devices, the first voltage signal appearing at the eighth output terminal when the control signal has the second voltage level.

In some aspects, the techniques described herein relate to a control system comprising: an independent alternating-input (“IAI”) device having a first voltage input and a second voltage input; and a LED driver electrically connected to the IAI device and configured to: receive, via a data input terminal, a serial data stream on a data line; generate, based on the data, a first voltage signal and a second voltage signal; and output, via a first output terminal electrically connected to the first voltage input and a second output terminal electrically connected to the second voltage input, the first voltage signal and the second voltage signal, wherein the LED driver is further configured to: in a first state of the IAI device, set the first voltage signal and the second voltage signal to have similar voltage levels; and in a second state of the IAI device, set the first voltage signal and the second voltage signal to have different voltage levels.

In some aspects, the techniques described herein relate to a control system wherein: the first voltage input is electrically connected in parallel to a first pull-up resistor connected to a voltage bus signal; and the second voltage input is electrically connected in parallel to a second pull-up resistor connected to the voltage bus signal and a capacitor connected to ground.

In some aspects, the techniques described herein relate to a control system wherein the control system further includes an inverter electrically connected to the first output terminal and the second output terminal of the LED driver and the first voltage input and the second voltage input of the IAI device, the inverter configured to: receive a power supply signal; receive, from the LED driver, the first voltage signal and the second voltage signal, each electrical connection between the LED driver and the inverter including a first pull-up resistor connected to a third voltage signal; and output an inverted first voltage signal and an inverted second voltage signal to the IAI device, each electrical connection between the inverter and the IAI device including a second resistor.

In some aspects, the techniques described herein relate to a control system wherein the control system further includes a first transistor and a second transistor electrically connected between the LED driver and the IAI device, wherein: a base of the first transistor and the second transistor is electrically connected to the first output terminal and the second output terminal of the LED driver, respectively, and in parallel to a first pull-up resistor connected to a third voltage signal; an emitter of the first transistor and the second transistor is electrically connected to ground; and a collector of the first transistor and the second transistor is electrically connected to the first voltage input and the second voltage input of the IAI device, respectively, and in parallel to a second pull-up resistor connected to a voltage bus signal.

In some aspects, the techniques described herein relate to a control system wherein the control system further includes a first transistor and a second transistor electrically connected between the LED driver and the IAI device, wherein: a base of the first transistor and the second transistor is electrically connected to a first pull-up resistor connected to a third voltage signal; an emitter of the first transistor and the second transistor is electrically connected to the first output terminal and the second output terminal of the LED driver, respectively; and a collector of the first transistor and the second transistor is electrically connected to the first voltage input and the second voltage input of the IAI device, respectively, and in parallel to a second pull-up resistor connected to a voltage bus signal.

In some aspects, the techniques described herein relate to a control system wherein the control system further includes a level shifter electrically connected to the first output terminal and the second output terminal of the LED driver and the first voltage input and the second voltage input of the IAI device, the level shifter configured to: receive a power supply signal; receive, from the LED driver, the first voltage signal and the second voltage signal, each electrical connection between the LED driver and the level shifter including a first pull-up resistor connected to a third voltage signal; and output a shifted first voltage signal and a shifted second voltage signal to the IAI device, each electrical connection between the level shifter and the IAI device including a second resistor.

### Example Environment for IAI Devices

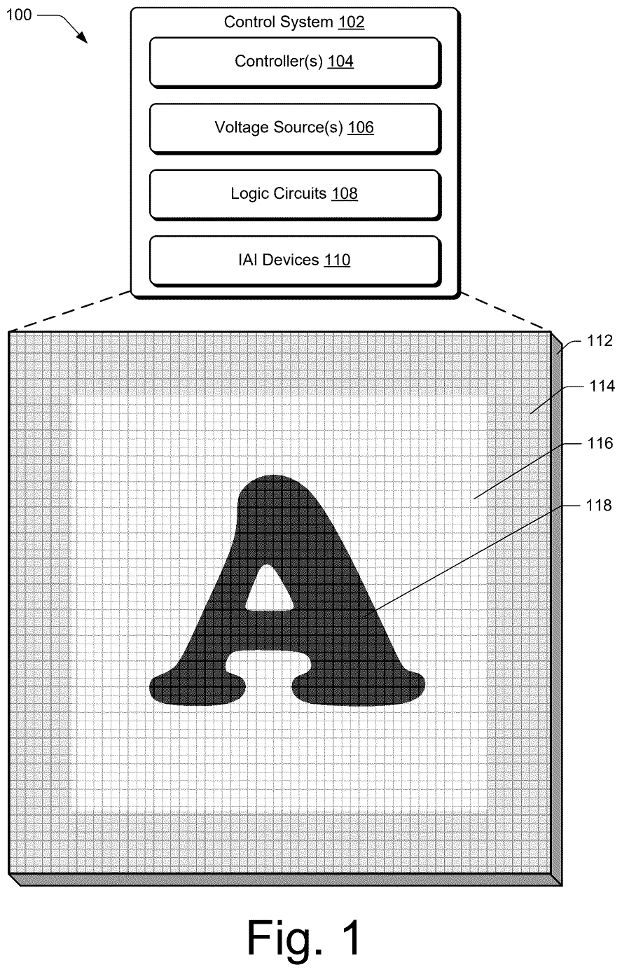

FIG. 1 illustrates an environment 100 in an example implementation that is operable to employ low-cost control circuits for IAI devices as described herein. The environment 100 includes a control system 102 in which multiple IAI devices can be controlled (e.g., to generate dynamic displays). The control system 102 includes one or more controllers 104, one or more voltage sources 106, multiple logic circuits 108, and multiple IAI devices 110. As shown, FIG. 1 illustrates the control system 102, which includes multiple IAI devices 110. The IAI devices 110 are connected to logic circuits 108, which are managed by the controller 104 (e.g., a microcontroller).

The controller 104 provides a control signal to the logic circuits 108 to indicate when each logic circuit should provide one or more voltage signals to the IAI devices 110. In addition, the controller 104 provides a synchronization clock to synchronize the logic circuits 108 with each other. For example, the controller 104 utilizes a Serial Peripheral Interface (SPI) to provide input signals, power, clock signals, and other signals to the logic circuits 108. In various implementations, the controller 104 is a microprocessor having memory (e.g., RAM) and programmed instructions (e.g., in hardware or software) to manage the control system 102 and IAI devices 110 therein.

The one or more voltage sources 106 provide one or more voltage signals to the logic circuits 108 and/or the IAI devices 110. For example, the voltage source 106 provides a first voltage signal, such as a positive voltage level, and a second voltage signal, such as a negative voltage level, to one or more of the logic circuits 108. The logic circuits 108 receive the first and second voltage signals via a particular electrical connection (e.g., a single input) or multiple connections (e.g., an input for the first voltage signal and an additional input for the second voltage signal). In another example, the voltage source 106 provides a first voltage signal to the logic circuits 108 and a second voltage signal to the IAI devices 110 without routing through the logic circuits 108. The voltage source 106 provides a constant voltage signal, which the logic circuits 108 convert into an alternating voltage signal, such as a square wave, a triangle wave, a sinusoidal wave (e.g., AC waveform), or another alternating voltage signal suitable for the IAI devices 110.

The control system 102 supports multiple IAI devices 110 that can be included in flexible arrangements and displays. The control system 102 independently controls multiple IAI devices 110 via a particular logic circuit 108. Controlling multiple IAI devices 110 via a particular logic circuit 108 reduces the weight and expenses associated with flexible displays. The use of low-cost logic circuits 108 can increase the quantity of IAI devices 110 that may be attached to a flexible display, improving configurability of the flexible display. The increased configurability expands the quantity or type of IAI devices used in different creative arrangements. For example, if the flexible display is included on a large wall or window surface, a designer can create relatively complex visual patterns (or other interactions) by utilizing a larger quantity of controllable devices.

In some implementations, an IAI device 110 includes a device suitable for wearable electronics. Examples of IAI devices 110 for wearable electronics include light-emitting diodes (“LEDs”), polymer dispersed liquid crystal (“PDLC”) devices, polychromic material devices, speakers or other sound devices, motors (e.g., low-voltage motors), solenoids (e.g., electromagnets), or any other type of device suitable for including in a flexible display or other flexible arrangements.

An IAI device 110 is configured to receive, for example, at least one voltage signal with alternating voltage levels, such as a square wave, a triangle wave, a sinusoidal wave, a non-periodic digital signal (e.g., rising or falling based on a control signal), or other types of voltage signals that alternate levels. In some cases, an IAI device 110 is configured to receive a voltage signal alternating at a particular frequency, such as at about 50 Hz. An IAI device 110 can operate based on a voltage signal at positive and/or negative 1.5V, 3.3V, 5V, 7V, 15V, 30V, 60V, or another suitable level of relatively low voltage (e.g., within a range of about +60V to about −60V). In some cases, a particular range of relatively low voltages may be suitable for a particular type of flexible display or IAI device 110. For example, a voltage range of about +60V to about −60V may be suitable for a flexible display on an architectural wall. In addition, a voltage range of about +15V to about −15V may be suitable for a flexible display on a wearable electronics item.

In some implementations, the control system 102 includes hardware and/or software that facilitates sending and receiving data from an external source. For example, the control system 102 receives designs, patterns, and/or animations to display on a set of IAI devices 110. For instance, the control system 102 communicates with a phone application to receive one or more stored designs. Similarly, the control system 102 can receive animations from a proximity beacon at an event (e.g., a concert or fashion show), from adjacent objects, or other IAI devices (e.g., a fixed modular reflective light-diffuser device display or another individual wearing modular reflective light-diffuser devices). In various implementations, the control system 102 receives wireless transmissions (e.g., WI-FI, Bluetooth, NFC). In alternative implementations, the control system 102 downloads designs, patterns, and/or animations via a physical port (e.g., a data and recharging port). Further, the control system 102 can receive one or more stored designs via flash memory, such as an SD card.

As mentioned above, IAI devices 110, including PDLC diffuser components and corresponding modular light-diffuser devices, can be utilized on various types of surfaces, including surfaces of portable and non-portable objects. To illustrate, FIG. 1 includes a wall 112 that includes a collection of IAI devices 110 (e.g., modular light-diffuser devices), forming a first pattern 114, a second pattern 116, and a third pattern 118. The first pattern 114 forms a rectangular border around the second pattern 116, which includes a background display (e.g., here a solid color). The third pattern 118 forms a letter “A”. As shown, the patterns 114, 116, and 118 are made up of the IAI devices 110 arranged into a grid of rows and columns to create a dense dot matrix of pixels (e.g., texture pixels or texels). In various implementations, IAI devices 110 are attached to the wall 112 by taping or otherwise fastening them (e.g., crimping, screwing, gluing, sewing) to the wall 112. Because IAI devices 110 are connected via a flexible conductor and are not rigidly connected, the IAI devices 110 can be attached in a manner that does not meaningfully impede movement or use of the wall 112 or other surfaces.

Each modular light-diffuser device, as an example of an IAI device 110, is operable to change from a light-scattering state to a transparent state when power is applied. For example, when modular light-diffuser devices are not powered, they can appear white, cloudy, diffuse, or partially opaque. If the wall 112 is similar in color and material, the modular light-diffuser devices appear hidden in the light-scattering state. When power is applied, the modular light-diffuser devices become transparent, revealing the material beneath the diffuser elements. For example, when the modular light-diffuser devices are placed above a reflective, mirror-like material, the mirror is visible when the modular light-diffuser devices are in a transparent state.

To illustrate, FIG. 1 shows the modular light-diffuser devices as a decorative material attached to the wall 112. When power is cut off to each modular light-diffuser device, the modular light-diffuser devices become opaque (e.g., white, cloudy, and/or diffuse). In contrast, driving power to each modular light-diffuser device causes them to reveal the reflective material (e.g., mylar) behind the diffuser elements of the modular light-diffuser devices in the form of the first, second, and third patterns 114, 116, and 118. In other implementations, the modular light-diffuser devices can be partially activated to become partially opaque (e.g., in between the “white” of the opaque state and the color of the reflective material). In another implementation, the second pattern 116 is generated by not activating the corresponding modular light-diffuser devices.

In various implementations, different groups of modular light-diffuser devices are powered to create different pixelated designs. In other implementations, the modular light-diffuser devices switch between different designs to create animations (e.g., based on a user providing touch input or triggering a switch). To illustrate, the wall 112 can animate different letters and/or words by alternating between different activation states in different patterns.

In some implementations, the underlying surface has a reflective background material behind the modular light-diffuser devices. However, the material of the surface can vary in substance, color, and design. For example, in some implementations, the surface material is a dark or colored fabric. In one or more embodiments, the surface has a printed or woven pattern that appears when the modular light-diffuser devices are in the transparent state.

The control system 102 changes the state of the IAI devices 110 (e.g., between the light-scattering state and the non-light-scattering state) as well as provides generated alternating current to the IAI devices 110 based on sending signals to the logic circuits 108 via the controller 104.

In one implementation, the control system 102 arranges the IAI devices 110 into rows and columns, with individual IAI devices 110 activated at the intersections. This matrix arrangement allows row and column wires to control row-by-column IAI devices 110, which is more cost-effective than a single wire for each IAI device 110. Arranged in a matrix, one electrode or voltage input from each vertically-aligned IAI device 110 connects to the same column, and the other electrode or voltage input from each horizontally-aligned IAI device 110 connects to the same row. Because the columns are shared, each row or scanline of IAI devices 110 is individually activated. Passive-matrix displays cycle through the scanlines quickly and constantly because the IAI devices 110 cannot sustain their state while the scanline is inactive. In contrast, active-matrix displays have additional components (e.g., transistors, capacitors, etc.) per IAI device 110 that sustain the state while the scanline is inactive. Alternatively, direct-drive displays do not employ grid addressing and instead dedicate one or more wires per IAI device 110 for activation. Due to the high quantity of IAI devices 110, these wires are usually routed to serially-chained integrated circuits (ICs) instead of a main controller 104.

Each IAI device 110 includes two voltage inputs (e.g., LTx and RTx). A BUS signal is an externally generated AC signal alternating between HIGH and LOW. An !BUS signal is the opposite of the current BUS state (e.g., if BUS=LOW, !BUS=HIGH). The column (Cx) and row (Rx) signals are also externally generated, and the columns are supplied with the BUS or !BUS signal. Exact VDD, VSS, HIGH, and LOW voltages depend on the ratings (e.g., single vs. dual supply) of the ICs and IAI devices 110 used. A resistor can be added in series with the global BUS signal to prevent a short circuit in case of gate latency between the global BUS source and the IC outputs.

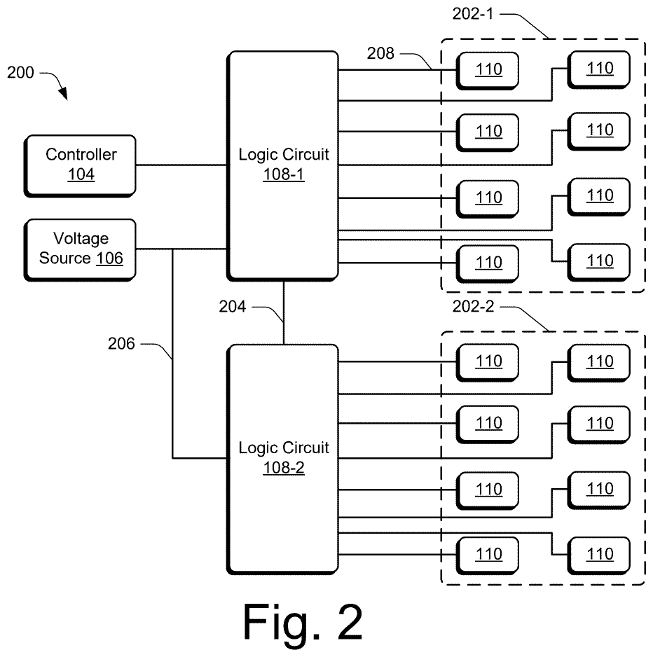

The described techniques for passive-matrix, active-matrix, and direct-drive control schemes involve significantly fewer components at a fraction of the cost. In particular, the described techniques use various components (e.g., quad analog switches, four-bit d-type latches, shift registers, and LED drivers) that employ passive-matrix, active-matrix, and direct-drive schemes to dramatically reduce the cost per IAI device for a given size (e.g., up to three hundred times less), which is described in greater detail with respect to FIGS. 2 through 7E.

In general, functionality, features, and concepts described in the examples above and below are employed in the context of the example procedures described in this section. Further, functionality, features, and concepts described with different figures and examples in this document are interchangeable and are not limited to implementation in the context of a particular figure or procedure. Moreover, blocks associated with different representative procedures and corresponding figures herein are applicable together and/or combinable in different ways. Thus, individual functionality, features, and concepts described with different example environments, devices, components, figures, and procedures herein are usable in any suitable combinations and are not limited to the particular combinations represented by the enumerated examples in this description.

### Example Control Signals

FIG. 2 illustrates an example system 200 employing low-cost control circuits for IAI devices as described herein.

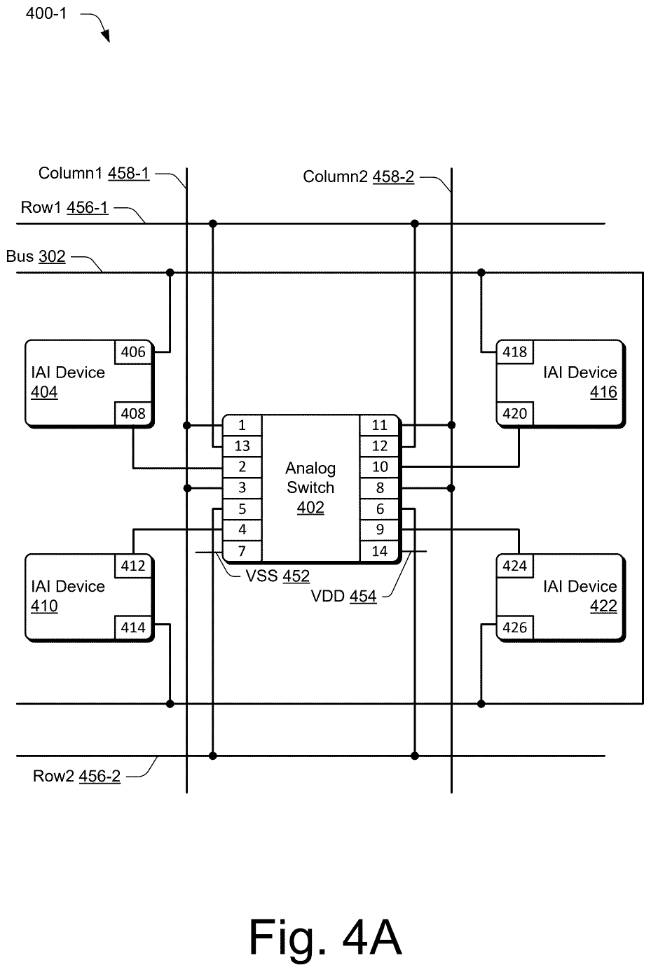

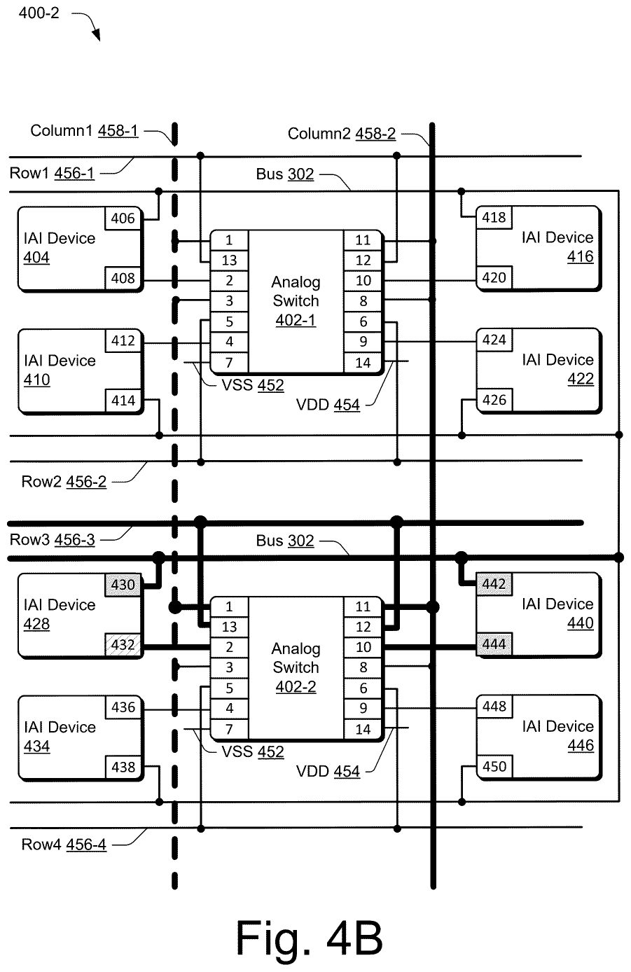

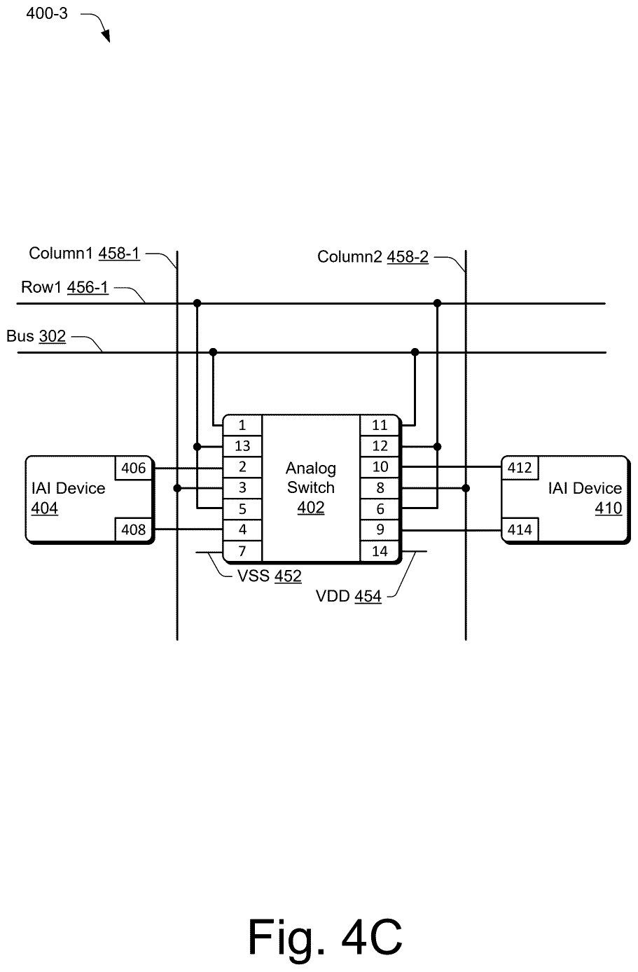

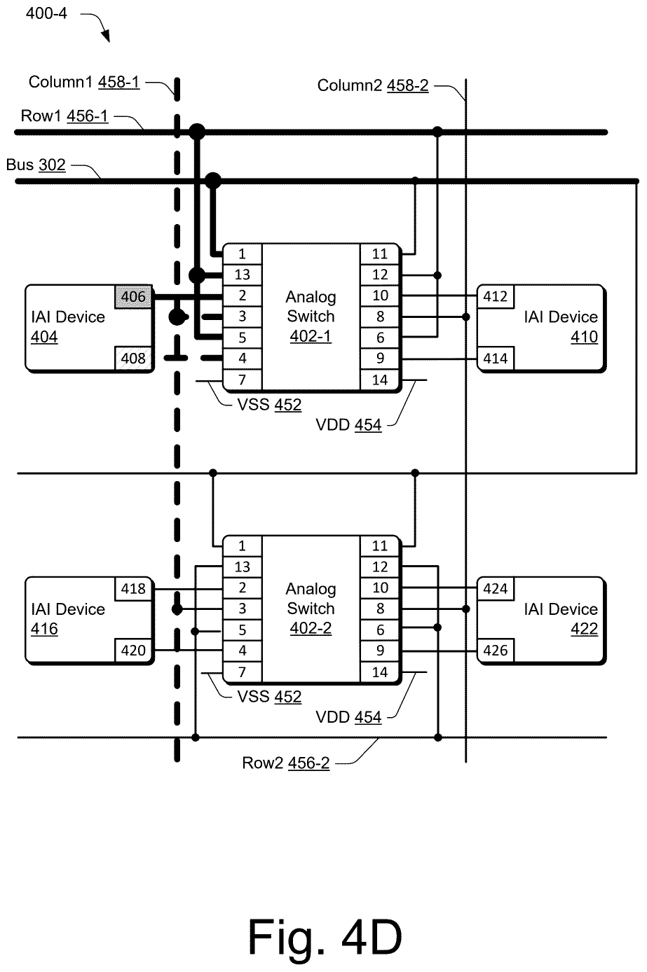

The system 200 includes one or more controllers 104 and voltage sources 106. In addition, the system 200 includes one or more logic circuits 108, such as a first logic circuit 108-1 and a second logic circuit 108-2, and one or more IAI devices 110, such as a first group 202-1 of IAI devices 110 operatively connected to the first logic circuit 108-1 and a second group 206-2 of IAI devices 110 operatively connected to the second logic circuit 108-2. Each group of IAI devices includes multiple IAI devices 110, such as between two to eight IAI devices 110. In some cases, the system 200 includes one or more additional logic circuits 108 connected to additional groups 202 of IAI devices 110. For example, one or more additional logic circuits 108 may be connected in a serial configuration (e.g., “daisy chain”) to the first logic circuit 108-1. In some cases, each additional logic circuit 108 may be connected to a respective group 202 of additional IAI devices 110. An example logic circuit 108 includes an analog switch component, a d-type latch component, or a shift register as described in greater detail with respect to FIGS. 4A through 6B, but other types of logic circuit components may be suitable.

In FIG. 2, the controller 104 is a microprocessor, LED controller, or other suitable control component configured to generate a control signal. The control signal includes a digital control signal that utilizes synchronous communication protocol. An example protocol for a digital control signal includes a serial peripheral interface (“SPI”) communication protocol, but other suitable protocols for digital control signals may be utilized. In the system 200, one or more logic circuits 108 receive a digital control signal from the controller 104. In some implementations, a particular digital control signal is provided from the first logic circuit 108-1 to the second logic circuit 108-2. For example, the digital control signal from the controller 104 is provided from the first logic circuit 108-1 to the second logic circuit 108-2 via a control line 204. In addition, the second logic circuit 108-2 can be configured to provide the digital control signal to an additional logic circuit in the system 200, such as via an additional control line 204.

In some implementations, a digital control signal is generated or repeated by one or more components in the system 200, such as applying signal conditioning techniques to a received digital control signal that has fallen below a threshold voltage level. For example, the system 200 can include one or more components configured to refresh a digital control signal, store the digital control signal in a buffer, or other suitable configurations for signal conditioning of a digital control signal. In some implementations, a digital control signal protocol that can be signal-conditioned by an analog switch (or other logic circuit component) may improve manufacturability or reduce the costs of a multi-device control system, such as by reducing the number of controllers or signal-repeating components included in the example multi-device control system.

System 200 is described as having a particular digital control signal from controller 104, but other implementations are possible. For example, system 200 may include multiple controllers 104 configured to provide digital control signals. In addition, system 200 may include a particular controller 104 configured to provide multiple digital control signals, or a digital control signal with multiple components (e.g., time division, frequency division) that are received and/or interpreted by respective logic circuits 108. In addition, system 200 may receive a digital control signal from an additional component, such as via an antenna configured to communicate wirelessly with a controller 104 located remotely from system 200.

The voltage source 106 is configured to provide one or more voltage signals to at least one logic circuit 108. For example, the voltage source 106 provides a first voltage signal, such as a positive voltage level, and a second voltage signal, such as a negative voltage level, to one or more of the logic circuits 108. The logic circuits 108 receive the first and second voltage signals via a particular electrical connection (e.g., a single input) or multiple connections (e.g., an input for the first voltage signal and an additional input for the second voltage signal). The voltage source 106 provides a constant voltage signal, which the logic circuits 108-1 and 108-2 convert into an alternating voltage signal, such as a square wave, a triangle wave, a sinusoidal wave (e.g., AC waveform), or another alternating voltage signal suitable for the IAI devices 110.

FIG. 2 depicts the logic circuits 108 as receiving voltage signals from the voltage source 106, but other implementations are possible. For example, system 200 can include a signal-generating analog switch that generates at least one voltage signal (e.g., a square wave signal) based on one or more voltage signals received from a voltage source 106. In some cases, one or more additional analog switches can receive the at least one voltage signal from the signal-generating analog switch component.

In some implementations, each logic circuit 108 provides control voltage signals to multiple IAI devices 110. The control voltage signals to the IAI devices 110 can be based on one or more voltage signals received by the logic circuits 108 or provided directly to the IAI devices 110 without being received via the logic circuits 108. For example, the first logic circuit 108-1 provides a respective set of control voltage signals to each IAI device 110 in the first group 202-1 of IAI devices 110. A particular IAI device 110 in the first group 202-1 receives, for instance, a first voltage signal via a first voltage input and a second voltage signal via a second voltage input. In addition, each additional IAI device 110 in the first group 202-1 receives from the first logic circuit 108-1 a respective voltage signal and additional voltage signal via respective voltage inputs. Similarly, the second logic circuit 108-2 provides a respective set of control voltage signals to each IAI device 110 in the second group 202-2.

In some cases, each logic circuit 108 provides the respective voltage signal(s) to each IAI device 110 responsive to the digital control signal from the controller 104. For example, the digital control signal includes data for each IAI device 110, indicating whether each device is activated or deactivated. In some implementations, the data in the digital control signal indicates an address (or other identification data) for each IAI device 110. In addition, the data in the digital control signal can indicate whether one or more logic circuits 108 are activated or deactivated (e.g., open or closed). For example, the digital control signal includes data indicating activation for a set of switches, latches, registers, or other circuitry associated with a particular IAI device 110, such as a set of switches, latches, or registers electrically connected to voltage input(s) of the particular device. Each switch, latch, or register in the set of logical circuits 108 can be configured to connect and disconnect a voltage input of the particular IAI device 110 with a respective input connection of the logic circuit 108. Responsive to the digital control signal, the logic circuit 108 activates the set of switches, latches, or registers for the particular IAI device 110, such that the particular IAI device 110 receives the input voltage signals via the voltage inputs. In addition, the particular IAI device 110 activates (or deactivates) responsive to receiving the control voltage signals. States of activation or deactivation include powering on, powering off, adjusting an output level (e.g., adjusting volume, modifying color), entering a standby state, or other suitable types of operation for the IAI device 110.

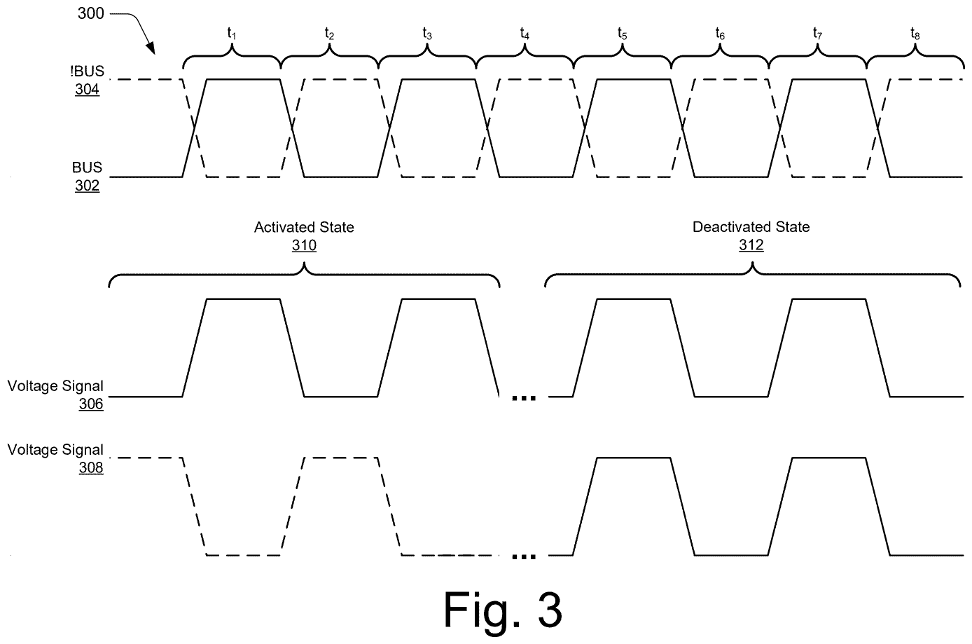

Additional details of the input voltage signals received by the IAI devices 110 is provided with respect to FIG. 3. Additional examples and details of the arrangement of the logic circuits 108 within control systems implementing passive-matrix, active-matrix, and direct-drive schemes are provided with respect to FIGS. 4A through 7E.

FIG. 3 is a diagram 300 depicting example voltage signals provided by low-cost control circuits for IAI devices. In some cases, the example voltage signals are used to control one or more IAI devices 110. The IAI devices 110 are electrically connected to a logic circuit component, such as the logic circuit 108-1 or 108-2.

In some implementations, the control system includes a signal-generating component (also referred to herein as a “bus-generating component”). A bus-generating component can be configured to generate one or more voltage signals, such as a signal bus (also referred to herein as a “bus 302” or “BUS”) or an inverted signal bus (also referred to herein as an “inverted bus 304” or “!BUS”). The bus 302 can include a voltage signal with voltage levels that alternate based on a time period, such as a square wave that alternates at a frequency of 50 Hz or another frequency. In addition, the inverted bus 304 can include a voltage signal with voltage levels that alternate based on the time period of the bus. The voltage levels of the inverted bus 304 can be different from the voltage levels of the bus 302. For example, a bus 302 and an inverted bus 304 may alternate voltage levels at the same (or similar) time periods. In this example, during a first time period, bus 302 has a relatively high voltage level, and the inverted bus 304 has a relatively low voltage level (or vice-versa). Continuing in this example, during a second time period immediately subsequent to the first time period, bus 302 has a relatively low voltage level, and inverted bus 304 has a relatively high voltage level.

In particular, the bus 302 and the inverted bus 304 include respective voltage levels. The respective voltage levels may alternate between (or otherwise include) a relatively higher voltage V+ and a relatively lower voltage V− (e.g., about +15V to about −15V, or other suitable voltages). For example, the bus 302 includes the lower voltage V− at the first, third, fifth, and seventh time periods and includes the higher voltage V+ at the second, fourth, sixth, and eighth time periods. In addition, the inverted bus 304 includes the higher voltage V+ at the first, third, fifth, and seventh time periods, and includes the lower voltage V− at the second, fourth, sixth, and eighth time periods. In some cases, the voltage signals of the bus 302 and inverted bus 304 alternate at a particular frequency, such as a frequency of about 50 Hz. In some implementations, a voltage signal of about 50 Hz may reduce or prevent degradation of some types of IAI devices 110, such as PDLC devices. For convenience, and not by way of limitation, FIG. 3 depicts waveforms associated with bus 302 using a solid line and waveforms associated with inverted bus 304 using a dotted line.

In some implementations, the bus 302 and inverted bus 304 are generated by one or more components of the control system, such as by an analog switch component. In some cases, the analog switch component generates the voltage signals by activating or deactivating (e.g., opening or closing) multiple switches included in the analog switch component. For example, each of the logic circuits 108 generates or passes through the bus 302 and/or inverted bus 304 by opening and closing switches or similar circuitry electrically connected to the voltage source 106. In some cases, bus 302 and inverted bus 304 are generated by a signal-generating component, which can be configured to provide the voltage signals to one or more additional components or directly to each IAI device via a bus line or similar electrical connection.

In some implementations, a first voltage signal 306 and a second voltage signal 308 are provided to the IAI devices 110, such as via a first voltage input (e.g., LTx) or a second voltage input (e.g., RTx). The voltage inputs are electrically connected to, for example, a set of switches, latches, registers, or other circuitry included in the logic circuit 108. In addition, the logic circuit 108 modifies states (e.g., activates or deactivates) of the internal circuitry of the logic circuit 108 to generate a temporal combination of the first and second voltage signals at the IAI devices 110. The combinations of the bus 302 and inverted bus 304 generate the first voltage signal 306 and the second voltage signal 308. For example, the logic circuit 108 modifies internal states such that the first voltage signal 306 includes the bus 302 (e.g., as indicated by the solid line) during the first through eighth time period at a first voltage input of the IAI device 110. In addition, the logic circuit 108 modifies internal states such that the second voltage signal 308 includes the inverted bus 304 (e.g., as indicated by the dashed line) during the first through fourth time period and includes the bus 302 (e.g., as indicated by the solid line) during the fifth through eighth time period. Other combinations of voltage signals may be generated via additional suitable modifications to internal states of the logic circuit 108 as described in greater detail with respect to FIGS. 4A through 7E.

In FIG. 3, the first voltage signal 306 is received by an IAI device 110 via the first voltage input (e.g., LTx). The second voltage signal 308 is received by the IAI device 110 via the second voltage input (e.g., RTx). In some cases, the IAI device 110 enters an activated state 310 during the first through fourth time periods, responsive to the voltage signals 306 and 308. For example, the IAI device 110 may enter the activated state 310 responsive to receiving a voltage differential across the voltage inputs, such as a differential between the different voltage levels of the bus 302 and inverted bus 304 during these time periods. In addition, the IAI device 110 enters a deactivated state 312 during the fifth through eighth time period, responsive to the voltage signals 306 and 308. For example, the IAI device 110 enters the deactivated state 312 responsive to a reduced or absent voltage differential (e.g., similar voltage levels) across the voltage inputs, such as the similar voltage levels of the bus 302 during these time periods.

In some cases, the IAI device 110 is controlled, e.g., activated or deactivated, via a presence or absence of a sufficient voltage differential across the voltage inputs, such as differentials between the voltage levels included in the voltage signals 306 and 308. In addition, the logic circuit 108 controls the IAI device 110 individually, such that the IAI device 110 can have different, identical, or partly related activity as compared to other IAI devices 110. As used herein, a voltage differential that is “sufficient” is a voltage differential with a value that activates an IAI device receiving the voltage differential across multiple voltage inputs. In some cases, particular types of IAI devices may activate responsive to a sufficient voltage differential with a particular value. In addition, particular types of IAI devices may activate with particular responses (e.g., faster/slower activation, color selection activation) based on a value of a sufficient voltage differential. For example, a PDLC device could activate responsive to a sufficient voltage differential of about 30 V. In addition, a speaker device could activate at a first frequency responsive to a sufficient voltage differential of about 20 mV and at a second frequency responsive to a sufficient voltage differential of about 5 mV. Other types of IAI devices with additional sufficient voltage differentials may be utilized.

In some implementations, one or more of the bus 302 or inverted bus 304 or the voltage signals 306 or 308 are modified via pulse width modulation (“PWM”). For instance, a control system could include a PWM component configured to modify a voltage signal provided by a voltage source or a logic circuit component. In addition, a logic circuit component could modify internal states such that a voltage signal has a particular voltage level for relatively shorter or longer amounts of time. In some cases, an IAI device modifies an output responsive to receiving a PWM-modified control voltage signal, such as activating a motor or light-emitting component for relatively shorter or longer periods of time.

### Example Passive-matrix Control Circuits

FIGS. 4A, 4B, 4C, and 4D are diagrams depicting examples of a passive-matrix control system 400-1, 400-2, 400-3, and 400-4, respectively, to provide low-cost control circuits for IAI devices. Passive-matrix control circuits are implemented using analog switches 402. Examples of analog switches 402 include CD4016B (offered by Texas Instruments®), DG212B (offered by Vishay Siliconix®), and ADG442 (offered by Analog Devices®).

For the passive-matrix control system 400-1 of FIG. 4A, the analog switch 402 is electrically connected to four IAI devices: IAI device 404 with voltage inputs 406 and 408, IAI device 410 with voltage inputs 412 and 414, IAI device 416 with voltage inputs 418 and 420, and IAI device 422 with voltage inputs 424 and 426. One voltage input from each IAI device 110 is connected to the bus 302. As illustrated, voltage input 406 of IAI device 404, voltage input 414 of IAI device 410, voltage input 418 of IAI device 416, and voltage input 426 of IAI device 422 are connected to bus 302. In FIG. 4A, the bus 302 is shared among each IAI device 110. In another implementation, the bus 302 is generated for each scanline (or row line).

The other voltage input for each IAI device 110 is selectively connected to a shared column line 458 through one of the analog switch outputs. As illustrated, voltage input 408 of IAI device 404 is connected to terminal 2 (OUT) of the analog switch 402, voltage input 412 of IAI device 410 is connected to terminal 4 (OUT) of the analog switch 402, voltage input 420 of IAI device 416 is connected to terminal 10 (OUT) of the analog switch 402, and voltage input 424 of IAI device 422 is connected to terminal 9 (OUT) of the analog switch 402. The first column line 458-1 is selectively connected to voltage input 408 of IAI device 404 via terminal 1 (IN) of the analog switch 402 and to voltage input 412 of IAI device 410 via terminal 3 (IN) of the analog switch 402. Similarly, the second column line 458-2 is selectively connected to voltage input 420 of IAI device 416 via terminal 11 (IN) of the analog switch 402 and to voltage input 424 of IAI device 422 via terminal 8 (IN) of the analog switch 402.

Terminal 7 of the analog switch 402 is electrically connected to the ground or negative supply voltage (VSS) 452. Terminal 14 of the analog switch 402 is electrically connected to the positive supply voltage (VDD) 454.

The row lines 456 are electrically connected to control terminals of the analog switch 402 to control the selective connection between the voltage inputs and column lines 458. In particular, the first row line (row1) 456-1 is electrically connected to terminals 13 and 12 (CONTROL), which are associated with IAI devices 404 and 416. The second row line (row2) 456-2 is electrically connected to terminals 5 and 6 (CONTROL), which are associated with IAI devices 410 and 422.

When the corresponding row lines 456 (e.g., row1 456-1 for IAI devices 404 and 416 and row2 456-2 for IAI devices 410 and 422) is active (Rx=HIGH at terminals 5, 6, 12, and 13), both voltage inputs of the IAI devices are connected to a signal. If the column line 458 (e.g., column1 458-1 for IAI devices 404 and 410 and column2 458-2 for IAI devices 416 and 422) carries the inverted bus 304 (Cx=!BUS), the IAI device is activated because there is a voltage differential between the voltage inputs. If the column line 458 carries the bus 302 (Cx=BUS), the IAI device is deactivated because there is not a voltage differential. When the corresponding row line 456 is inactive (Rx=LOW), the voltage input connected to the analog switch is an open circuit, causing the IAI device 110 to remain in or transition to the deactivated state depending on the previous state. The row lines 456 are activated individually and in quick succession because the IAI devices 110 cannot sustain their state while the scanline is inactive (Rx=LOW). The column state for each row is set while the row line 456 is inactive.

The passive-matrix control system 400-2 of FIG. 4B is the same as the passive-matrix control system 400-1 of FIG. 4A, but includes a first analog switch 402-1 and a second analog switch 402-2. The first analog switch 402-1 is electrically connected to IAI devices 404, 410, 416, and 422. The second analog switch 402-2 is electrically connected to IAI devices 428, 434, 440, and 446.

Voltage inputs 406, 414, 418, 426, 430, 438, 442, and 450 of IAI devices 404, 410, 416, 422, 428, 434, 440, and 446, respectively, are electrically connected to the bus 302. The other voltage input for each IAI device is selectively connected to a shared column line 458 through one of the analog switch outputs. In particular, the other voltage input of IAI devices 404, 410, 428, and 434 is selectively connected to the first column line 458-1. The other voltage input of IAI devices 416, 422, 440, and 446 is selectively connected to the second column line 458-2. The first, second, third, and fourth row lines 456-1, 456-2, 456-3, and 456-4 are electrically connected to control terminals of the first analog switch 402-1 or the second analog switch 402-2 to control the selective connection between the voltage inputs and column lines 458.

For example, in the illustrated scenario of FIG. 4B, the third row line 456-3 associated with IAI devices 428 and 440 is active (Rx=HIGH at terminals 13 and 12 of the second analog switch 402-2, as illustrated by the thick, solid line), both voltage inputs of the IAI devices 428 and 440 are connected to a signal. As mentioned above, the bus 302 (as illustrated by the thick, solid line) is directly connected to voltage inputs 430 and 442 of IAI devices 428 and 440, respectively. Because the first column line 458-1 for IAI device 428 carries the inverted bus 304 (Cx=!BUS, as illustrated by the thick, dashed column line), the IAI device 428 is activated because there is a voltage differential across the voltage inputs 430 and 432. Because the second column line 458-2 for IAI device 440 carries the bus 302 (Cx=BUS, as illustrated by the thick, solid column line), the IAI device 440 is deactivated because there is not a voltage differential across the voltage input 442 and 444. When the third row line 456-3 subsequently becomes inactive (Rx=LOW), the voltage input connected to the second analog switch 402-2 is an open circuit, causing the IAI device 428 to transition to the deactivated state and the IAI device 440 to remain in to the deactivated state.

The passive-matrix control system 400-3 of FIG. 4C functions similar to the passive-matrix control system 400-1 of FIG. 4A, except both voltage inputs of the IAI devices 110 selectively connect to a column line 458 and bus 302, respectively, through the analog switch 402. In this configuration, the IAI devices are isolated from the grid when the corresponding row lines 456 are inactive (Rx=LOW), which is utilized when the open/close times of the analog switch 402 are not sufficient for a desired display refresh rate.

For each analog switch 402 of the passive-matrix control system 400-3 of FIG. 4C, the analog switch 402 is electrically connected to two IAI devices: IAI device 404 with voltage inputs 406 and 408 and IAI device 410 with voltage inputs 412 and 414. One voltage input from each IAI device 110 is selectively connected to the bus 302 via the analog switch 402. As illustrated, voltage input 406 of IAI device 404 is selectively connected to bus 302 via terminal 2 (OUT) and terminal 1 (IN) of the analog switch 402. Voltage input 412 of IAI device 410 is selectively connected to bus 302 via terminal 10 (OUT) and terminal 11 (IN) of the analog switch 402. The bus 302 is shared among each IAI device or multiple rows of IAI devices in one implementation. In another implementation, the bus 302 is generated for each scanline (or row line).

The other voltage input for each IAI device 110 is selectively connected to a shared column line 458 through one of the analog switch outputs. As illustrated, voltage input 408 of IAI device 404 is connected to terminal 4 (OUT) of the analog switch 402 and voltage input 414 of IAI device 410 is connected to terminal 9 (OUT) of the analog switch 402. The first column line 458-1 is selectively connected to voltage input 408 of IAI device 404 via terminal 3 (IN) of the analog switch 402. Similarly, the second column line 458-2 is selectively connected to voltage input 414 of IAI device 410 via terminal 8 (IN) of the analog switch 402.

Terminal 7 of the analog switch 402 is electrically connected to the ground or negative supply voltage (VSS) 452. Terminal 14 of the analog switch 402 is electrically connected to the positive supply voltage (VDD) 454.

The first row line 456-1 is electrically connected to control terminals of the analog switch 402 to control the selective connection between the voltage inputs and bus 302 and column lines 458. In particular, the first row line (row1) 456-1 is electrically connected to terminals 5, 6, 12, and 13 (CONTROL).

When the first row line 456-1 is active (Rx=HIGH at terminals 5, 6, 12, and 13), both voltage inputs of the IAI devices are connected to a signal. If the column line 458 (e.g., column1 458-1 for IAI device 404 and column2 458-2 for IAI device 410) carries the inverted bus 304 (Cx=!BUS), the IAI device is activated because there is a voltage differential between the voltage inputs. If the column line 458 carries the bus 302 (Cx=BUS), the IAI device is deactivated because there is not a voltage differential. When the first row line 456-1 is inactive (Rx=LOW), the voltage inputs are open circuits, causing the IAI device 110 to remain in or transition to the deactivated state depending on the previous state. The row lines 456 are activated individually and in quick succession because the IAI devices 110 cannot sustain their state while the scanline is inactive (Rx=LOW). The column state for each row is set while the row line 456 is inactive.

The passive-matrix control system 400-4 of FIG. 4D is the same as the passive-matrix control system 400-3 of FIG. 4C, but includes a first analog switch 402-1 and a second analog switch 402-2. The first analog switch 402-1 is electrically connected to IAI devices 404 and 410. The second analog switch 402-2 is electrically connected to IAI devices 416 and 422.

Voltage inputs 406, 412, 418, and 424 of IAI devices 404, 410, 416, and 422, respectively, are selectively connected to the bus 302 through one of the analog switch outputs. The other voltage input for each IAI device is selectively connected to a shared column line 458 through one of the analog switch outputs. In particular, the other voltage input of IAI devices 404 and 416 is selectively connected to the first column line 458-1. The other voltage input of IAI devices 410 and 422 is selectively connected to the second column line 458-2. The first and second row lines 456-1 and 456-2 are electrically connected to control terminals of the first analog switch 402-1 and the second analog switch 402-2, respectively, to control the selective connection between the voltage inputs and bus 302 or column lines 458.

For example, in the illustrated scenario of FIG. 4D, when the first row line 456-1 associated with IAI devices 404 and 410 is active (Rx=HIGH at terminals 13 and 12 of the first analog switch 402-1, as illustrated by the thick, solid line), both voltage inputs of the IAI device 404 are connected to a signal. As mentioned above, the bus 302 (as illustrated by the thick, solid line) is connected to voltage input 406 of IAI devices 404 in response to the first row line 456-1 being active. Because the first column line 458-1 for IAI device 404 carries the inverted bus 304 (Cx=!BUS, as illustrated by the thick, dashed column line), the IAI device 404 is activated because there is a voltage differential across the voltage inputs 406 and 408. When the first row line 456-1 subsequently becomes inactive (Rx=LOW), the voltage inputs of IAI device 404 are open circuits, causing the IAI device 404 to transition to the deactivated state.

### Example Active-Matrix Control Circuits

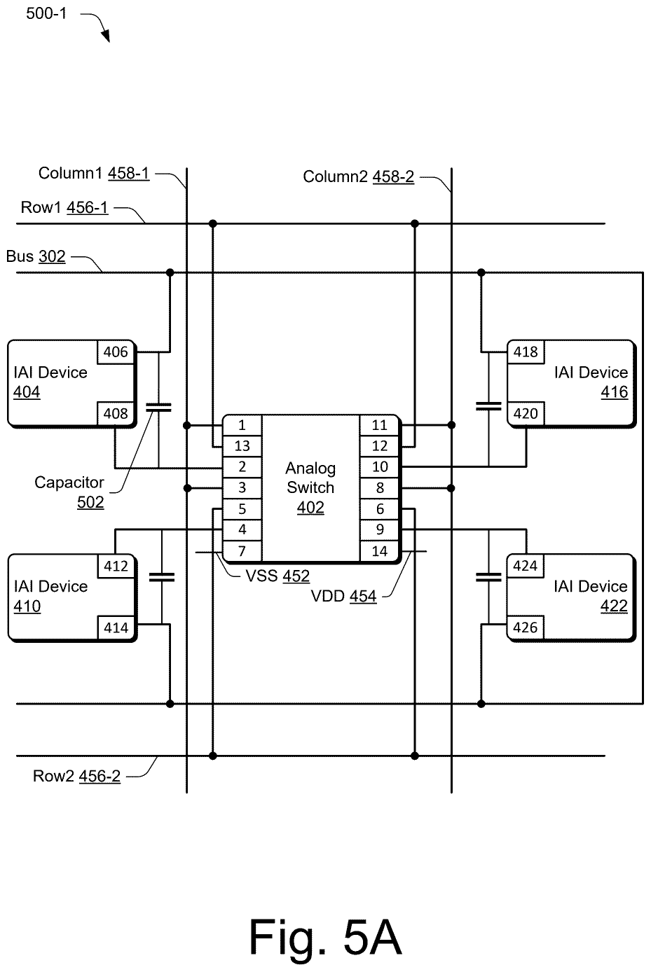

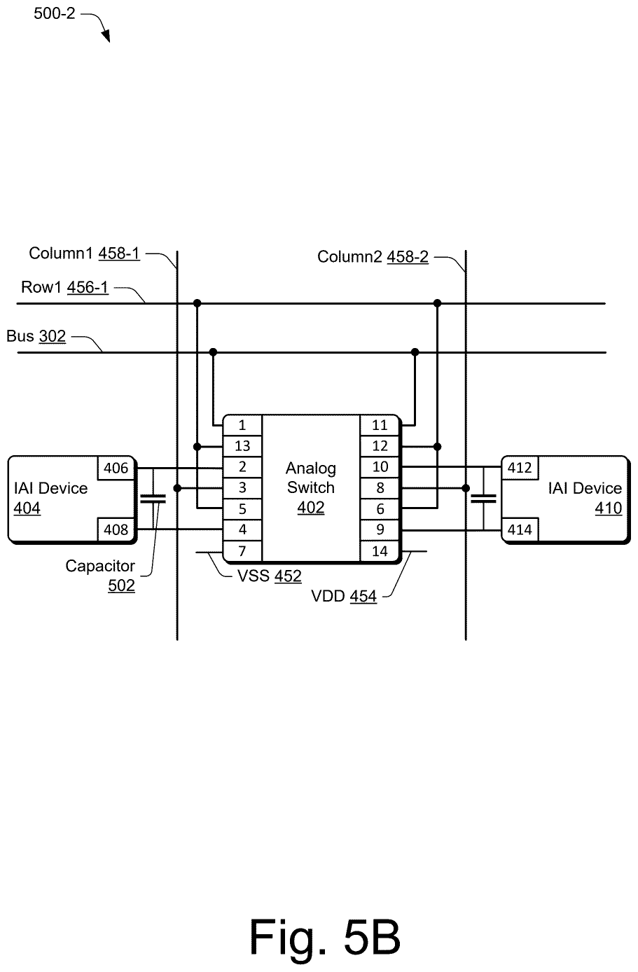

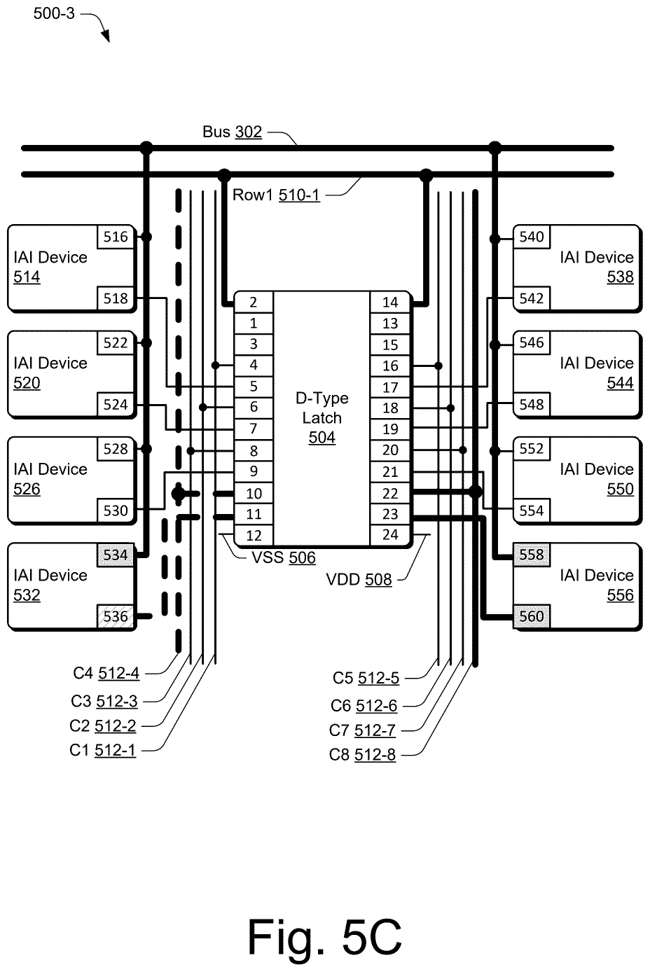

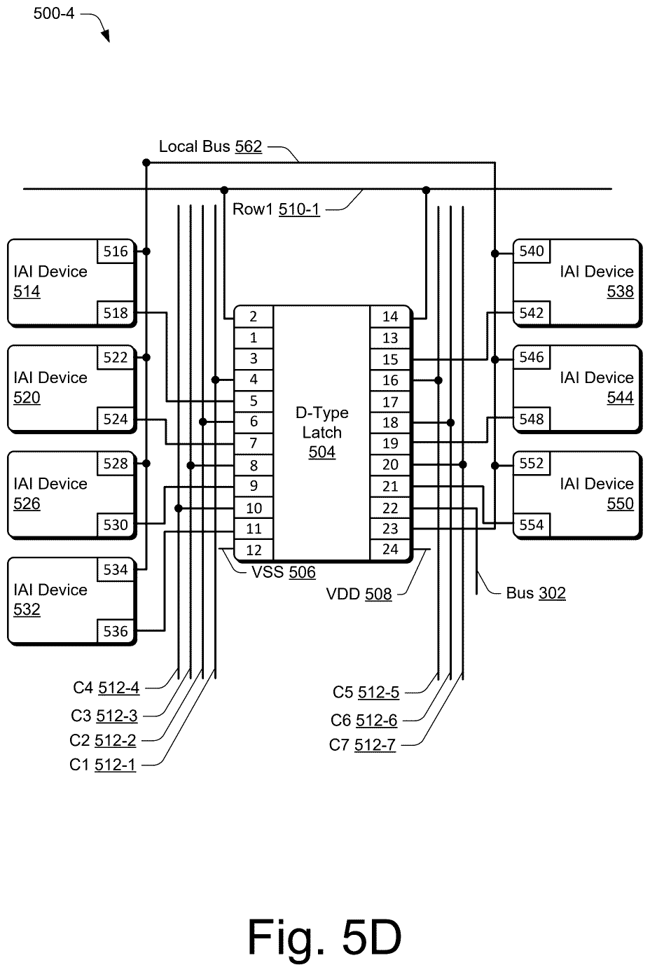

FIGS. 5A, 5B, 5C, and 5D are diagrams depicting examples of an active-matrix control system 500-1, 500-2, 500-3, and 500-4, respectively, to provide low-cost control circuits for IAI devices.

In FIGS. 5A and 5B, active-matrix control circuits are implemented using analog switch 402, IAI devices 404, 410, 416, and 422, VSS 452, VDD 454, bus 302, row lines 456, and column lines 458 as described with respect to FIGS. 4A and 4C. Active-matrix control systems 500-1 and 500-2 are similar to passive-matrix control systems 400-1 and 400-3, respectively, but add a capacitor 502 in parallel to the voltage inputs of each IAI device. When a corresponding scanline (e.g., row line 456-1 or 456-2) is active (Rx=HIGH), the capacitor 502 is charged while the corresponding IAI device 110 is activated. While the scanline is inactive (Rx=LOW), the corresponding IAI device 110 remains activated because the capacitor maintains the charge until the next refresh cycle (e.g., when Rx=HIGH again). The size of capacitor 502, which corresponds to a charge time for the capacitor 502, is chosen based on the refresh rate utilized.

In FIGS. 5C and 5D, active-matrix control systems 500-3 and 500-4, respectively, are implemented using d-type latches 504. An example of a d-type latch 504 includes CD4508 (offered by Texas Instruments®).

For active-matrix control system 500-3, each d-type latch 504 is electrically connected to eight IAI devices 110: IAI device 514 with voltage inputs 516 and 518, IAI device 520 with voltage inputs 522 and 524, IAI device 526 with voltage inputs 528 and 530, IAI device 532 with voltage inputs 534 and 536, IAI device 538 with voltage inputs 540 and 542, IAI device 544 with voltage inputs 546 and 548, IAI device 550 with voltage inputs 552 and 554, and IAI device 556 with voltage inputs 558 and 560. One voltage input from each IAI device 110 is connected to a global bus signal (e.g., the bus 302). As illustrated, voltage input 516 of IAI device 514, voltage input 522 of IAI device 520, voltage input 528 of IAI device 526, voltage input 534 of IAI device 532, voltage input 540 of IAI device 538, voltage input 546 of IAI device 544, voltage input 552 of IAI device 550, and voltage input 558 of IAI device 556 are connected to bus 302. In FIG. 5C, the bus 302 is shared among each IAI device 110. In another implementation, the bus 302 is generated for each scanline (or row line).

The other voltage input for each IAI device 110 is connected to one of the latch outputs of the d-type latch 504. As illustrated, voltage input 518 of IAI device 514 is connected to terminal 5 (Q0A) of the d-type latch 504, voltage input 524 of IAI device 520 is connected to terminal 7 (Q1A), voltage input 530 of IAI device 526 is connected to terminal 9 (Q2A), voltage input 536 of IAI device 532 is connected to terminal 11 (Q3A), voltage input 542 of IAI device 538 is connected to terminal 17 (Q0B), voltage input 548 of IAI device 544 is connected to terminal 19 (Q1B), voltage input 554 of IAI device 550 is connected to terminal 21 (Q2B), voltage input 560 of IAI device 556 is connected to terminal 23 (Q3B).

Each latch input of the d-type latch 504 is connected to a shared column line. As illustrated, terminal 4 (D0A) is connected to the first column line (C1) 512-1, terminal 6 (D1A) is connected to the second column line (C2) 512-2, terminal 8 (D2A) is connected to the third column line (C3) 512-3, terminal 10 (D3A) is connected to the fourth column line (C4) 512-4, terminal 16 (D0B) is connected to the fifth column line (C5) 512-5, terminal 18 (D1B) is connected to the sixth column line (C6) 512-6, terminal 20 (D2B) is connected to the seventh column line (C7) 512-7, and terminal 22 (D3B) is connected to the eighth column line (C8) 512-8.

Each latch output (e.g., terminals 5, 7, 9, 11, 17, 19, 21, and 23) copies the state of the corresponding latch input (e.g., terminals 4, 6, 8, 10, 16, 18, 20, and 22, respectively) when the row (e.g., the first row line 510-1), which is connected to terminals 2 and 14 (STROBE_A and STROBE_B) is active (Rx=HIGH). When the row is inactive (Rx=LOW), each latch output maintains the state the output latch had the last time the row was active, regardless of the current state of the input latch (e.g., a shared column line). The desired column state (e.g., corresponding to the latch input) is set while the row(s) are inactive.

Terminal 12 of the d-type latch 504 is electrically connected to the ground or negative supply voltage (VSS) 506. Terminal 24 of the d-type latch 504 is electrically connected to the positive supply voltage (VDD) 508.

If the column line 512 carries the inverted bus 304 (Cx=!BUS), the corresponding IAI device is activated because there is a voltage differential between the voltage inputs. If the column line 512 carries the bus 302 (Cx=BUS), the IAI device is deactivated because there is not a voltage differential. The voltage input connected to the latch output is not open circuit at any time, resulting in the IAI device being driven to an activated or deactivated state.

For example, in the illustrated scenario of FIG. 5C, the bus 302 (as illustrated by the thick, solid line) is directly connected to voltage inputs 534 and 558 of IAI devices 532 and 556, respectively. The latch input at terminal 10 (D3A) is connected to the fourth column line 512-4, which carries the inverted bus 304 (as illustrated by the thick, dashed line). The latch input at terminal 22 (D3B) is connected to the eighth column line 512-8, which carries the bus 302 (as illustrated by the thick, solid line). When the first row line 510-1 is active (Rx=HIGH at terminals 2 and 14 of the d-type latch 504, as illustrated by the thick, solid line), the latch outputs at terminal 11 (Q3A) and terminal 23 (Q3B) copy the state of the latch inputs at terminal 10 (D3A) and terminal 22 (D3B), respectively. Because the fourth column line 512-4 for IAI device 532 carries the inverted bus 304 (Cx=!BUS, as illustrated by the thick, dashed column line), the IAI device 532 is activated because there is a voltage differential across the voltage inputs 534 and 536. Because the eighth column line 512-8 for IAI device 556 carries the bus 302 (Cx=BUS, as illustrated by the thick, solid column line), the IAI device 556 is deactivated because there is not a voltage differential across the voltage input 558 and 560. When the first row line 510-1 subsequently becomes inactive (Rx=LOW), the latch outputs at terminal 11 (Q3A) and terminal 23 (Q3B) maintain their previous states and the IAI devices 532 and 556 also maintain their previous states.

The active-matrix control system 500-4 of FIG. 5D functions similar to the active-matrix control system 500-3 of FIG. 5C, except one latch output terminal is utilized to generate the bus 302 locally for each d-type latch 504 or scanline (e.g., row 1 510-1). For example, a global bus line (bus 302) is connected to a latch input at terminal 22 (D3B), and a local bus 562 is connected to the latch output at terminal 23 (Q3B).

For active-matrix control systems 500-4, each d-type latch 504 is electrically connected to seven IAI devices: IAI device 514 with voltage inputs 516 and 518, IAI device 520 with voltage inputs 522 and 524, IAI device 526 with voltage inputs 528 and 530, IAI device 532 with voltage inputs 534 and 536, IAI device 538 with voltage inputs 540 and 542, IAI device 544 with voltage inputs 546 and 548, and IAI device 550 with voltage inputs 552 and 554. One voltage input from each IAI device 110 is connected to the local bus 562. As illustrated, voltage input 516 of IAI device 514, voltage input 522 of IAI device 520, voltage input 528 of IAI device 526, voltage input 534 of IAI device 532, voltage input 540 of IAI device 538, voltage input 546 of IAI device 544, and voltage input 552 of IAI device 550 are connected to local bus 562.

The other voltage input for each IAI device 110 is connected to one of the remaining latch outputs of the d-type latch 504. As illustrated, voltage input 518 of IAI device 514 is connected to terminal 5 (Q0A) of the d-type latch 504, voltage input 524 of IAI device 520 is connected to terminal 7 (Q1A), voltage input 530 of IAI device 526 is connected to terminal 9 (Q2A), voltage input 536 of IAI device 532 is connected to terminal 11 (Q3A), voltage input 542 of IAI device 538 is connected to terminal 17 (Q0B), voltage input 548 of IAI device 544 is connected to terminal 19 (Q1B), and voltage input 554 of IAI device 550 is connected to terminal 21 (Q2B).

Each remaining latch input of the d-type latch 504 is connected to a shared column line. As illustrated, terminal 4 (D0A) is connected to the first column line (C1) 512-1, terminal 6 (D1A) is connected to the second column line (C2) 512-2, terminal 8 (D2A) is connected to the third column line (C3) 512-3, terminal 10 (D3A) is connected to the fourth column line (C4) 512-4, terminal 16 (D0B) is connected to the fifth column line (C5) 512-5, terminal 18 (D1B) is connected to the sixth column line (C6) 512-6, and terminal 20 (D2B) is connected to the seventh column line (C7) 512-7.

Each latch output (e.g., terminals 5, 7, 9, 11, 17, 19, and 21) copies the state of the corresponding latch input (e.g., terminals 4, 6, 8, 10, 16, 18, and 20, respectively) when the row line (e.g., the first row line 510-1), which is connected to terminals 2 and 14 (STROBE_A and STROBE_B) is active (Rx=HIGH). When the row line is inactive (Rx=LOW), each latch output maintains the state the output latch had the last time the row line was active, regardless of the current state of the input latch (e.g., a shared column line). The desired column state (e.g., corresponding to the latch input) is set while the row line(s) are inactive.

Terminal 12 of the d-type latch 504 is electrically connected to the ground or negative voltage supply (VSS) 506. Terminal 24 of the d-type latch 504 is electrically connected to the positive voltage supply (VDD) 508.

If column line 512 carries the inverted bus 304 (Cx=!BUS), the corresponding IAI device is activated because there is a voltage differential between the voltage inputs. If column line 512 carries the bus 302 (Cx=BUS), the IAI device is deactivated because there is not a voltage differential. The voltage input connected to the latch output is not open circuit at any time, resulting in the IAI device being driven to an activated or deactivated state.

### Example Direct-Drive Control Circuits

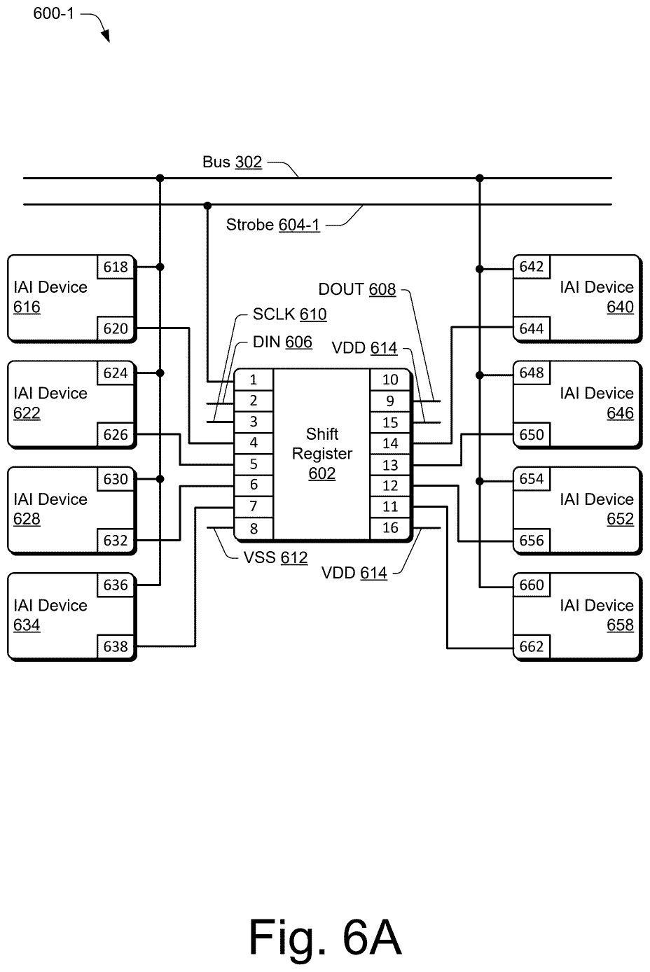

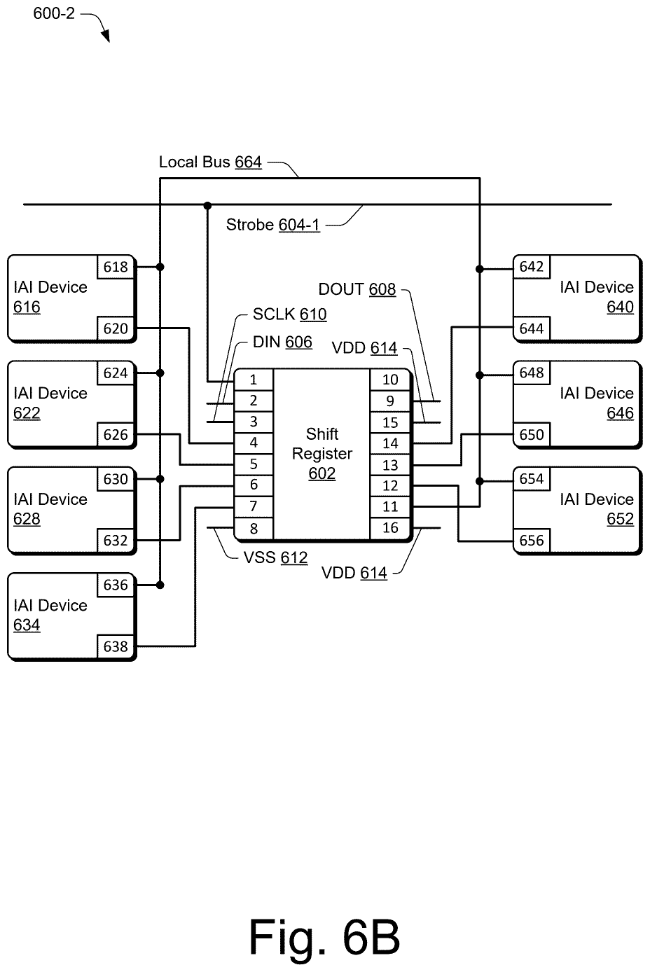

FIGS. 6A and 6B are diagrams depicting examples of a direct-drive control system 600-1 and 600-2, respectively, to provide low-cost control circuits for IAI devices. In FIGS. 6A and 6B, direct-drive control systems 600-1 and 600-2, respectively, are implemented using shift registers 602 that include a latch. An example of a shift register 602 includes CD4094B (offered by Texas Instruments®).

For direct-drive control systems 600-1, each shift register 602 is electrically connected to eight IAI devices: IAI device 616 with voltage inputs 618 and 620, IAI device 622 with voltage inputs 624 and 626, IAI device 628 with voltage inputs 630 and 632, IAI device 634 with voltage inputs 636 and 638, IAI device 640 with voltage inputs 642 and 644, IAI device 646 with voltage inputs 648 and 650, IAI device 652 with voltage inputs 654 and 656, and IAI device 658 with voltage inputs 660 and 662. One voltage input from each IAI device 110 is connected to a global bus line (e.g., the bus 302). As illustrated, voltage input 618 of IAI device 616, voltage input 624 of IAI device 622, voltage input 630 of IAI device 628, voltage input 636 of IAI device 634, voltage input 642 of IAI device 640, voltage input 648 of IAI device 646, voltage input 654 of IAI device 652, and voltage input 660 of IAI device 658 are connected to bus 302. In FIG. 6A, the bus 302 is shared among each IAI device. In another implementation, the bus 302 is generated for each scanline (or row line).

The other voltage input for each IAI device 110 is connected to one of the shift register outputs of the shift register 602. As illustrated, voltage input 620 of IAI device 616 is connected to terminal 4 (Q1) of the shift register 602, voltage input 626 of IAI device 622 is connected to terminal 5 (Q2), voltage input 632 of IAI device 628 is connected to terminal 6 (Q3), voltage input 638 of IAI device 634 is connected to terminal 7 (Q4), voltage input 644 of IAI device 640 is connected to terminal 14 (Q5), voltage input 650 of IAI device 646 is connected to terminal 13 (Q6), voltage input 656 of IAI device 652 is connected to terminal 12 (Q7), voltage input 662 of IAI device 658 is connected to terminal 11 (Q8). Each shift register is serially chained and shares the strobe 604, data (e.g., DIN 606), and clock (e.g., SCLK 610) lines. The data for the other voltage inputs is shifted in serially (e.g., one bit at a time) via DIN 606 and output in parallel to the shift register outputs. In other words, the shift register 602 is a serial-in, parallel-out (SIPO) shift register. The data (e.g., DOUT 608) is then serially provided to the next shift register 602 in the chain as input data (e.g., DIN 606).

The value of DIN 606 (e.g., HIGH or LOW) is shifted into the registers of the shift register 602 when the strobe 604 is low (e.g., CS=LOW). When the strobe 604 is high (e.g., CS=HIGH), the data in the registers appears at the register outputs (e.g., terminals 4, 5, 6, 7, 11, 12, 13, and 14). Each output (e.g., terminals 4, 5, 6, 7, 11, 12, 13, and 14) maintains its state from the last time the strobe 604 was high, regardless of the data being shifted into the register (e.g., from DIN 606).

Terminal 8 of the shift register 602 is electrically connected to the ground or negative supply voltage (VSS) 612. Terminals 15 and 16 of the shift register 602 is electrically connected to the positive supply voltage (VDD) 614.

If the output (e.g., terminals 4, 5, 6, 7, 11, 12, 13, and 14) is inverted from the bus 302, the corresponding IAI device 110 is activated because there is a voltage differential between the voltage inputs. If the output matches the bus 302, the IAI device is deactivated because there is not a voltage differential. The voltage input connected to the register output is not open circuit at any time, resulting in the IAI device being driven to an activated or deactivated state.

The direct-drive control system 600-2 of FIG. 6B functions similar to the direct-drive control system 600-1 of FIG. 6A, except one output terminal is utilized to generate the bus 664 locally for each shift register 602 or subset of shift registers 602. For example, a global bus state is provided in the data stream to DIN 606 as a single bit for the local bus generated at terminal 11 for the local bus 664.

For direct-drive control systems 600-2, each shift register 602 is electrically connected to seven IAI devices: IAI device 616 with voltage inputs 618 and 620, IAI device 622 with voltage inputs 624 and 626, IAI device 628 with voltage inputs 630 and 632, IAI device 634 with voltage inputs 636 and 638, IAI device 640 with voltage inputs 642 and 644, IAI device 646 with voltage inputs 648 and 650, and IAI device 652 with voltage inputs 654 and 656. One voltage input from each IAI device 110 is connected to the local bus 664. As illustrated, voltage input 618 of IAI device 616, voltage input 624 of IAI device 622, voltage input 630 of IAI device 628, voltage input 636 of IAI device 634, voltage input 642 of IAI device 640, voltage input 648 of IAI device 646, and voltage input 654 of IAI device 652 are connected to local bus 664.

The other voltage input for each IAI device 110 is connected to one of the shift register outputs of the shift register 602. As illustrated, voltage input 620 of IAI device 616 is connected to terminal 4 (Q1) of the shift register 602, voltage input 626 of IAI device 622 is connected to terminal 5 (Q2), voltage input 632 of IAI device 628 is connected to terminal 6 (Q3), voltage input 638 of IAI device 634 is connected to terminal 7 (Q4), voltage input 644 of IAI device 640 is connected to terminal 14 (Q5), voltage input 650 of IAI device 646 is connected to terminal 13 (Q6), and voltage input 656 of IAI device 652 is connected to terminal 12 (Q7). Each shift register 602 is serially chained together and shares the strobe 604, data (e.g., DIN 606), and clock (e.g., SCLK 610) lines. The data (e.g., DOUT 608) is serially provided to the next shift register 602 in the chain as input data (e.g., DIN 606).

The value of DIN 606 (e.g., HIGH or LOW) is shifted into the registers of the shift register 602 when the strobe 604 is low (e.g., CS=LOW). When the strobe 604 is high (e.g., CS=HIGH), the data in the registers appears at the register outputs (e.g., terminals 4, 5, 6, 7, 11, 12, 13, and 14). Each output (e.g., terminals 4, 5, 6, 7, 11, 12, 13, and 14) maintains its state from the last time the strobe 604 was high, regardless of the data being shifted into the register (e.g., from DIN 606).

Terminal 8 of the shift register 602 is electrically connected to the ground or negative supply voltage (VSS) 612. Terminals 15 and 16 of the shift register 602 is electrically connected to the positive supply voltage (VDD) 614.

If the output (e.g., terminals 4, 5, 6, 7, 12, 13, and 14) is inverted from the local bus 664, the corresponding IAI device is activated because there is a voltage differential between the voltage inputs. If the output matches the local bus 664, the IAI device is deactivated because there is not a voltage differential. The voltage input connected to the register output is not open circuit at any time, resulting in the IAI device being driven to an activated or deactivated state.

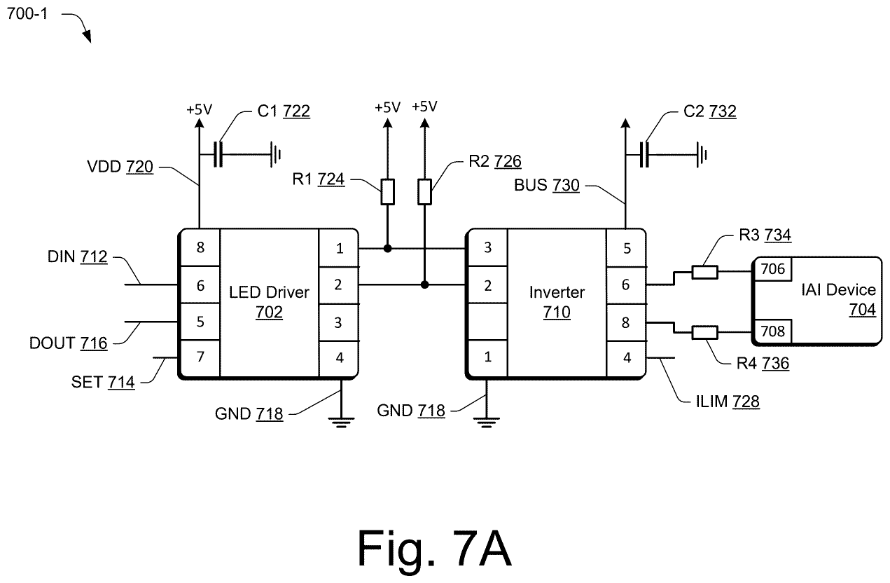

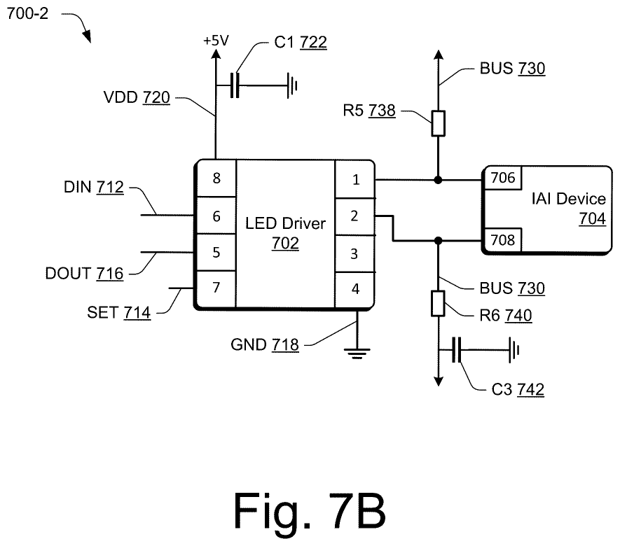

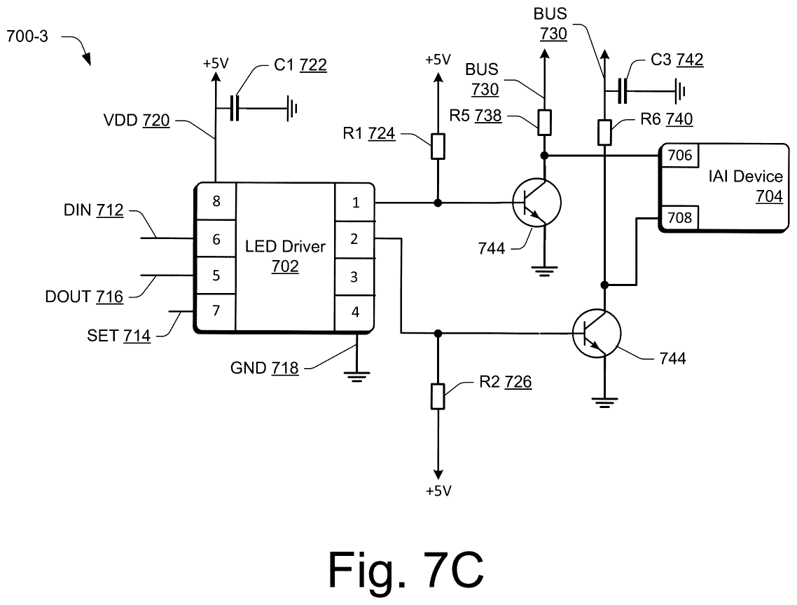

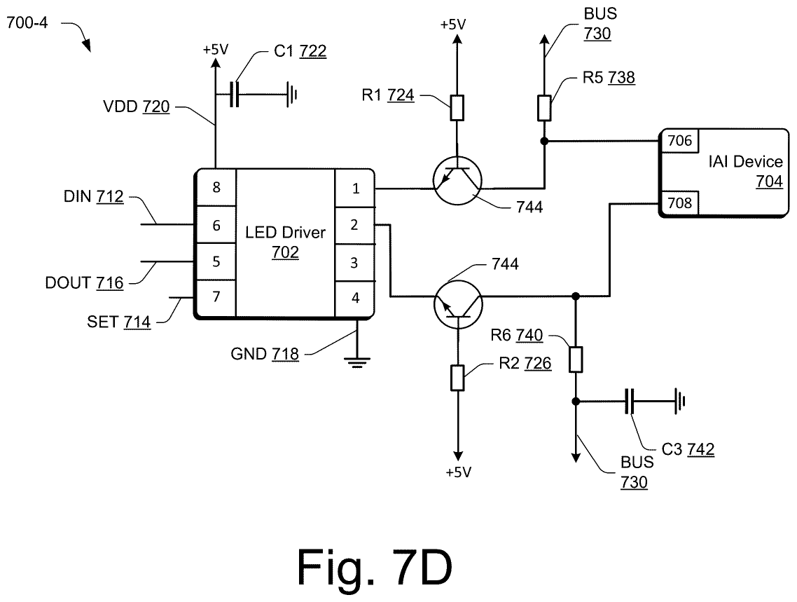

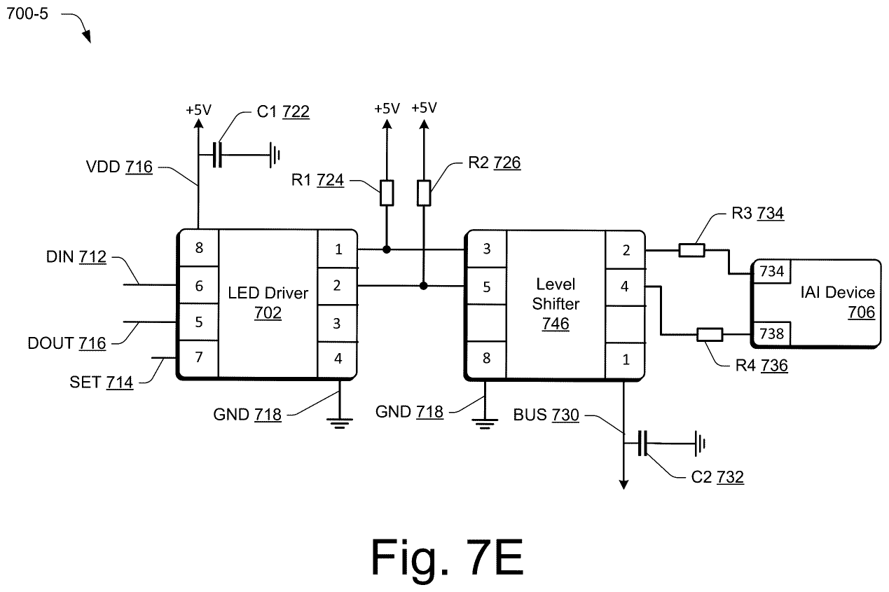

FIGS. 7A through 7E are diagrams depicting examples of a direct-drive control system 700-1 through 700-5 to provide low-cost control circuits for IAI devices. In FIGS. 7A through 7E, direct-drive control systems 700-1, 700-2, 700-3, 700-4, and 700-5, respectively, are implemented using LED drivers 702 daisy-chained together. An example of the LED driver 702 includes WS2811 (offered by Worldsemi®). In other implementations, the LED driver 702 includes a circuit with multiple outputs to drive one or more IAI devices 704. In the direct-drive control systems 700-1 through 7005, the LED drivers 702 refresh the control signals driving the IAI devices so that buffer chips are unnecessary between each LED driver.

Each LED driver 702 is electrically connected (e.g., directly or indirectly through the circuit) to an IAI device 704 with voltage inputs 706 and 708. The LED drivers 702 are serially or daisy chained and share the data (e.g., DIN 712) and mode (e.g., SET 714) lines. The data signal at DIN 712 is a serial data stream (e.g., with each voltage input represented by 8 bits) and the LED driver 702 latches a subset of the incoming data (e.g., addressed for the corresponding IAI device 704 or voltage inputs 706 and 708) to store it internally. In one implementation, each IAI device 704 has a unique address, allowing for direct-drive control. The stored data is decoded and provided to output terminals 1 and 2. The mode signal at SET 714 sets the work mode of the LED driver 702 to low speed or high speed. The data signal is output at terminal 5 (e.g., DOUT 716) to the next LED driver 702 in the chain as input data (e.g., DIN 712).

Terminal 4 of the LED driver 702 is electrically connected to ground (e.g., GND 718). Terminal 8 of the LED driver 702 is electrically connected to the positive supply voltage (e.g., VDD 720), illustrated as 5V in FIG. 7A. The VDD 720 is connected in parallel to a capacitor (e.g., C1 722) connected to ground. It is noted that an output terminal (terminal 3) of the LED driver 702 is not utilized in the illustrated implementation. In other implementations, a combination of two LED drivers 702 controls three IAI devices 704.

For direct-drive control systems 700-1, an inverter 710 is electrically connected between the LED driver 702 and the IAI device 704. An example of the inverter 710 includes DRV8871DDA (offered by Texas Instruments®), a full-bridge inverter that can control IAI devices 704 bidirectionally and regulate current outputs. In other implementations, two half-bridge inverters are electrically connected between the LED driver 702 and the IAI device 704.

The decoded data at output terminals 1 and 2 of the LED driver 702 are electrically connected to logic inputs (terminals 3 and 2, respectively) of the inverter 710. Each electrical connection between the LED driver 702 and the inverter 710 is electrically connected in parallel to the positive supply voltage (e.g., +5V) via resistors R1 724 and R2 726, respectively. R1 724 and R2 726 act as pull-up resistors.

Terminal 1 of the inverter 710 is electrically connected to ground (e.g., GND 718). Terminal 4 of the inverter 710 provides a current limit control (e.g., ILIM 728) by connecting a resistor (not illustrated in FIG. 7A) to ground to set the current chopping threshold. Terminal 5 of the inverter is electrically connected to a positive supply voltage (e.g., BUS 730), which is connected in parallel to a capacitor (e.g., C2 732) connected to ground. The supply voltage is selected based on the driving voltage appropriate for the IAI device 704.

The outputs of inverter 710 (e.g., at terminals 6 and 8) are electrically connected to voltage inputs 706 and 708 of IAI device 704, respectively, via resistors (e.g., R3 734 and R4 736). If the outputs (e.g., terminals 6 and 8 of inverter 710) are inverted or sufficiently offset from one another, the IAI device 704 is activated because there is a voltage differential between the voltage inputs 706 and 708. If the outputs match or are sufficiently close in value, the IAI device 704 is deactivated because there is no voltage differential. The voltage inputs 706 and 708 are not open circuits at any time, resulting in the IAI device 704 always being driven to an activated or deactivated state.

For direct-drive control systems 700-2, the decoded data at output terminals 1 and 2 of the LED driver 702 are electrically connected to voltage inputs 706 and 708 of IAI device 704, respectively. Both electrical connections to the IAI device 704 are connected in parallel to the positive supply voltage (e.g., BUS 730) with pull-up resistors R5 738 and R6 740. The size of resistors R5 738 and R6 740 is indirectly related to the transition rate for the IAI device 704, which makes direct-drive control system 700-2 better suited for static or low frame rate displays. The supply voltage is selected based on the driving voltage appropriate for the IAI device 704. The electrical connection to voltage input 708 is also connected in parallel to a capacitor (e.g., C3 740) connected to ground.

If the outputs (e.g., terminals 1 and 2 of LED driver 702) are inverted or sufficiently offset from one another, the IAI device 704 is activated because there is a voltage differential between the voltage inputs 706 and 708. If the outputs match or are sufficiently close in value, the IAI device 704 is deactivated because there is no voltage differential. The voltage inputs 706 and 708 are not open circuit at any time, resulting in the IAI device 704 being driven to an activated or deactivated state.

For direct-drive control systems 700-3, a transistor 744 is electrically connected between the LED driver 702 and the IAI device 704 on each connection line. An example of transistor 744 includes an NPN transistor, a type of bipolar junction transistor.

The decoded data at output terminals 1 and 2 of the LED driver 702 are electrically connected to the base of each transistor 744. Each electrical connection between the LED driver 702 and the transistor 744 is electrically connected in parallel to a positive supply voltage (e.g., +5V) via resistors R1 724 and R2 726, respectively, acting as pull-up resistors.

The emitter of each transistor 744 is electrically connected to ground (e.g., GND 718). The collector of each transistor 744 is electrically connected to a corresponding voltage input of the IAI device 704. Both electrical connections to the IAI device 704 are connected in parallel to the positive supply voltage (e.g., BUS 730) with pull-up resistors R5 738 and R6 740. The electrical connection to voltage input 708 is also connected in parallel to a capacitor (e.g., C3 740) connected to ground.

If the outputs (e.g., from the collectors of transistors 744) are inverted or sufficiently offset from one another, the IAI device 704 is activated because there is a voltage differential between the voltage inputs 706 and 708. If the outputs match or are sufficiently close in value, the IAI device 704 is deactivated because there is no voltage differential. The voltage inputs 706 and 708 are not open circuit at any time, resulting in the IAI device 704 being driven to an activated or deactivated state.

For direct-drive control systems 700-4, a transistor 744 is electrically connected between the LED driver 702 and the IAI device 704 on each connection line. An example of transistor 744 includes an NPN transistor, a type of bipolar junction transistor.

The decoded data at output terminals 1 and 2 of the LED driver 702 are electrically connected to the emitter of each transistor 744. The base of each transistor 744 is electrically connected to a positive supply voltage (e.g., +5V) via resistors R1 724 and R2 726, respectively, acting as pull-up resistors.

The collector of each transistor 744 is electrically connected to a corresponding voltage input of the IAI device 704. Both electrical connections to the IAI device 704 are connected in parallel to the positive supply voltage (e.g., BUS 730) with pull-up resistors R5 738 and R6 740. The electrical connection to voltage input 708 is also connected in parallel to a capacitor (e.g., C3 740) connected to ground.

If the outputs (e.g., from the collectors of transistors 744) are inverted or sufficiently offset from one another, the IAI device 704 is activated because there is a voltage differential between the voltage inputs 706 and 708. If the outputs match or are sufficiently close in value, the IAI device 704 is deactivated because there is no voltage differential. The voltage inputs 706 and 708 are not open circuit at any time, resulting in the IAI device 704 being driven to an activated or deactivated state.

For direct-drive control systems 700-5, a level shifter 746 is electrically connected between the LED driver 702 and the IAI device 704. An example of the level shifter 746 includes 74HC4050 (offered by NXP®), a hex non-inverting high-to-low level shifter with over-voltage tolerant inputs. In one implementation, the level shifter 746 includes six or more sets of inputs and outputs, allowing a single level shifter 746 to be used with multiple LED drivers 702 and multiple IAI devices 704.

The decoded data at output terminals 1 and 2 of the LED driver 702 are electrically connected to inputs (terminals 3 and 5, respectively) of the level shifter 746. Each electrical connection between the LED driver 702 and the level shifter 746 is electrically connected in parallel to the positive supply voltage (e.g., +5V) via resistors R1 724 and R2 726, respectively, acting as pull-up resistors.

Terminal 8 of the level shifter 746 is electrically connected to ground (e.g., GND 718). Terminal 1 of the level shifter 746 is electrically connected to a positive supply voltage (e.g., BUS 730), which is connected in parallel to a capacitor (e.g., C2 732) connected to ground. The supply voltage is selected based on the driving voltage appropriate for the IAI device 704.

The outputs of level shifter 746 (e.g., at terminals 2 and 4) are electrically connected to voltage inputs 706 and 708 of IAI device 704, respectively, via resistors (e.g., R3 734 and R4 736). If the outputs (e.g., terminals 2 and 4 of level shifter 746) are inverted or sufficiently offset from one another, the IAI device 704 is activated because there is a voltage differential between the voltage inputs 706 and 708. If the outputs match or are sufficiently close in value, the IAI device 704 is deactivated because there is no voltage differential. The voltage inputs 706 and 708 are not open circuit at any time, resulting in the IAI device 704 being driven to an activated or deactivated state.

### Example Computing Device

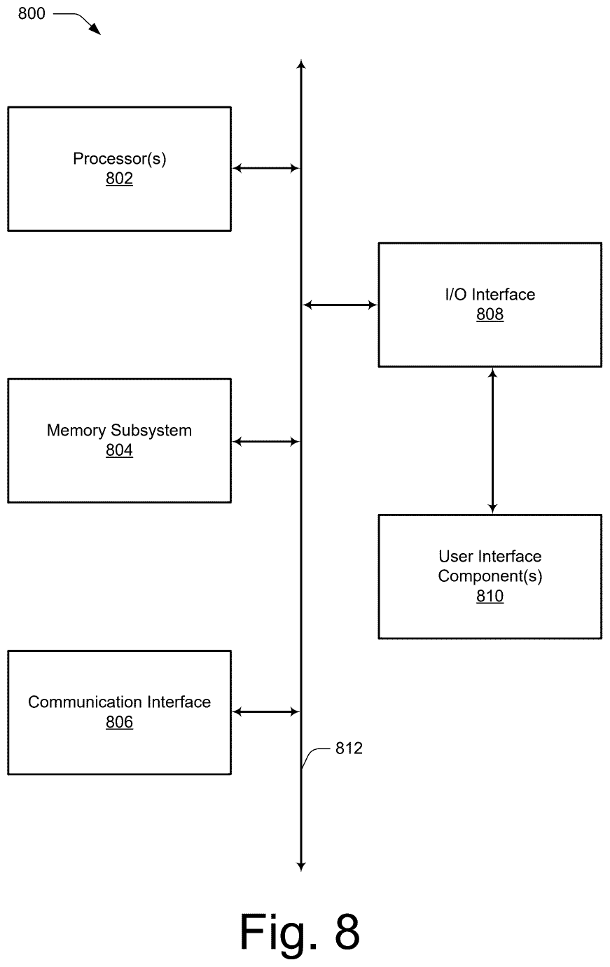

FIG. 8 illustrates an example of a computing device 800 according to aspects of the techniques described herein. The computing device 800 may implement a modular light-diffuser system that controls (e.g., directly or indirectly) one or more modular light-diffuser devices. In one aspect, computing device 800 includes processor(s) 802, memory subsystem 804, communication interface 806, I/O interface 808, user interface component(s) 810, and channel 812. Additional or alternative components may be used in other implementations.

In some embodiments, computing device 800 is an example of, or includes aspects of, the control system 102 of FIG. 1. In one or more implementations, the computing device 800 is a mobile device (e.g., a laptop, a tablet, a smartphone, a mobile telephone, a camera, a tracker, a watch, a wearable device, etc.). In other implementations, the computing device 800 is a non-mobile device (e.g., a desktop computer, a server device, a web server, a file server, a social networking system, a program server, an application store, or a content provider). Further, the computing device 800 may be a server device that includes cloud-based processing and storage capabilities. In some embodiments, computing device 800 includes one or more processors 802 that can execute instructions stored in memory subsystem 804 to perform media generation.

According to some aspects, computing device 800 includes one or more processors 802. In some cases, a processor 802 is an intelligent hardware device (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof). In some implementations, a processor 802 is configured to operate a memory array using a memory controller. In other cases, a memory controller is integrated into a processor 802. In some implementations, a processor 802 is configured to execute computer-readable instructions stored in memory to perform various functions. In some embodiments, a processor 802 includes special-purpose components for modem processing, baseband processing, digital signal processing, or transmission processing.

According to some aspects, memory subsystem 804 includes one or more memory devices. Examples of a memory device include random access memory (RAM), read-only memory (ROM), or a hard disk. Examples of memory devices include solid-state memory and a hard disk drive. In some examples, memory is used to store computer-readable, computer-executable software, including instructions that, when executed, cause a processor to perform various functions described herein. In some implementations, the memory contains, among other things, a basic input/output system (BIOS) that controls basic hardware or software operations, such as the interaction with peripheral components or devices. In some implementations, a memory controller operates memory cells. For example, the memory controller can include a row decoder, column decoder, or both. In some cases, memory cells within a memory store information in the form of a logical state.

According to some aspects, communication interface 806 operates at a boundary between communicating entities (such as computing device 800, one or more user devices, a cloud, and one or more databases) and channel 812 and can record and process communications. In some implementations, communication interface 806 enables a processing system coupled to a transceiver (e.g., a transmitter and/or a receiver). In some examples, the transceiver is configured to transmit (or send) and receive signals for a communications device via an antenna.

According to some aspects, I/O interface 808 is controlled by an I/O controller to manage input and output signals for computing device 800. In some implementations, I/O interface 808 manages peripherals not integrated into computing device 800. In some implementations, I/O interface 808 represents a physical connection or port to an external peripheral. In some implementations, the I/O controller uses an operating system such as iOS®, ANDROID®, MS-DOS®, MS-WINDOWS®, OS/2®, UNIX®, LINUX®, or other known operating system. In some implementations, the I/O controller represents or interacts with a modem, a keyboard, a mouse, a touchscreen, or a similar device. In some implementations, the I/O controller is implemented as a component of a processor. In some implementations, a user interacts with a device via I/O interface 820 or via hardware components controlled by the I/O controller.

According to some aspects, user interface component(s) 810 enable a user to interact with computing device 800. In some implementations, user interface component(s) 810 include an audio device, such as an external speaker system, an external display device, such as a display screen (e.g., with IAI devices 110), an input device (e.g., a remote-control device interfaced with a user interface directly or through the I/O controller), or a combination thereof. In some implementations, user interface component(s) 810 include a GUI.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are implementable on various commercial computing platforms with various processors.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

What is claimed is:

1. A control system comprising:
an independent alternating-input (“IAI”) device of multiple IAI devices, the IAI device having a first voltage input and a second voltage input, the first voltage input electrically connected to a bus line that provides a first voltage signal to the first voltage input; and
an analog switch electrically connected to the IAI device, the analog switch including:
an input terminal electrically connected to a column line of the control system; and
a switch configured to selectively connect and disconnect the input terminal of the analog switch and the second voltage input of the IAI device based on a control signal of a row line associated with the IAI device;
wherein the analog switch is configured to:
in a first state of the IAI device, provide a second voltage signal to the second voltage input via the switch; and
in a second state of the IAI device, provide the first voltage signal to the second voltage input via the switch.

2. The control system of claim 1, wherein:
the first voltage signal is a bus signal;
the second voltage signal is an inverted bus signal;
the first state of the IAI device is an activated state; and
the second state of the IAI device is a deactivated state.

3. The control system of claim 1, wherein the IAI device is configured to maintain or return to the second state when the switch is open.

4. The control system of claim 3, wherein:
each row line of multiple row lines of the control system are activated individually and in succession; and
the second voltage signal or the first voltage signal is applied to each column line of multiple column lines to set the input terminal when the row line is inactive.

5. The control system of claim 1, wherein:
the IAI device is a first IAI device and the control system further includes a second IAI device, a third IAI device, and a fourth IAI device;
the first voltage input of the first IAI device, the second IAI device, the third IAI device, and the fourth IAI device is directly connected to the bus line; and
the analog switch is further electrically connected to the second IAI device, the third IAI device, and the fourth IAI device and further includes:
a second input terminal and a fourth input terminal electrically connected to a second column line;
a third input terminal electrically connected to the column line;
a second switch configured to selectively connect and disconnect the second input terminal and the second voltage input of the second IAI device based on the control signal of the row line associated with the IAI device and the second IAI device;
a third switch configured to selectively connect and disconnect the third input terminal and the second voltage input of the third IAI device based on the control signal of a second row line associated with the third IAI device and the fourth IAI device; and
a fourth switch configured to selectively connect and disconnect the fourth input terminal and the second voltage input of the fourth IAI device based on the control signal of the second row line.

6. The control system of claim 1, wherein:
the IAI device is a first IAI device and the control system further includes a second IAI device;
the first voltage input of the first IAI device and the second IAI device is selectively connected to the bus line; and
the analog switch is electrically connected to the bus line and the second IAI device, the analog switch further includes:
a second input terminal and a fourth input terminal electrically connected to the bus line;
a second switch configured to selectively connect and disconnect the second input terminal of the analog switch and the first voltage input of the first IAI device based on the control signal;
a third input terminal electrically connected to a second column line; and
a fourth switch configured to selectively connect and disconnect the fourth input terminal of the analog switch and the first voltage input of the second IAI device based on the control signal.

7. The control system of claim 1, wherein:
the control system further includes a capacitor connected in parallel between the first voltage input and second voltage input of the IAI device ; and
the IAI device is configured to maintain a current state when the switch is open.

8. The control system of claim 7, wherein a size of the capacitor is based on a refresh rate of the multiple IAI devices.

9. The control system of claim 1, wherein the IAI device is one of a polymer dispersed liquid crystal visual element, a polychromic material visual element, a solenoid, a speaker, or a motor.

10. A control system comprising:
an independent alternating-input (“IAI”) device of multiple IAI devices, the IAI device having a first voltage input and a second voltage input, the first voltage input electrically connected to a bus line that provides a first voltage signal to the first voltage input; and
a d-type latch electrically connected to the IAI device, the d-type latch including:
a latch input terminal electrically connected to a column line; and
a latch output terminal electrically connected to the second voltage input of the IAI device and configured to copy a state of the latch input terminal based on a control signal of a row line associated with the IAI device,
wherein the d-type latch is configured to:
in a first state of the IAI device, provide a second voltage signal to the second voltage input via the latch output terminal; and
in a second state of the IAI device, provide the first voltage signal to the second voltage input via the latch output terminal.

11. The control system of claim 10, wherein the second voltage signal or the first voltage signal is applied to the column line to set a value of the latch input terminal when the row line is inactive.

12. The control system of claim 10, wherein:
the d-type latch is further electrically connected to at least six additional IAI devices;
the first state of the multiple IAI devices is an activated state;
the second state of the multiple IAI devices is a deactivated state; and
the multiple IAI devices are configured to maintain a current state.

13. The control system of claim 12, wherein:
the first voltage input of each IAI device is directly connected to the bus line; and
the d-type latch is electrically connected to at least eight IAI devices.

14. The control system of claim 12, wherein:
the first voltage input of each IAI device is selectively connected to the bus line; and
the d-type latch further includes:
an eighth latch input terminal electrically connected to the bus line; and
an eighth latch output terminal electrically connected to the first voltage input of the multiple IAI devices, the eighth latch output terminal configured to copy a state of the eighth latch input terminal based on the control signal of the row line.

15. A control system comprising:
an independent alternating-input (“IAI”) device of multiple IAI devices, the IAI device having a first voltage input and a second voltage input, the first voltage input electrically connected to a bus line that provides a first voltage signal to the first voltage input; and
a shift register electrically connected to the IAI device and including:
a register of multiple registers, the register configured to receive data from a data line when a control signal has a first voltage level; and
an output terminal of the register electrically connected to the second voltage input of the IAI device, the data appearing at the output terminal when the control signal has a second voltage level,
wherein the shift register is configured to:
in a first state of the IAI device, provide a second voltage signal to the second voltage input via the output terminal; and
in a second state of the IAI device, provide the first voltage signal to the second voltage input via the output terminal.

16. The control system of claim 15, wherein the second voltage signal or the first voltage signal is applied via the data line to set a value of the register when the control signal is low.

17. The control system of claim 15, wherein the control system further includes multiple shift registers that are serially connected and share the control signal and a clock line.

18. The control system of claim 15, wherein:
the shift register is further electrically connected to at least six additional IAI devices;
the first state of the multiple IAI devices is an activated state;
the second state of the multiple IAI devices is a deactivated state; and
the multiple IAI devices are configured to maintain a current state.

19. The control system of claim 18, wherein:
the first voltage input of each IAI device is directly connected to the bus line; and
the shift register is electrically connected to at least eight IAI devices.

20. The control system of claim 18, wherein:
the first voltage input of each IAI device is electrically connected to the bus line via an eighth output terminal of the shift register; and
the shift register further includes:
an eighth register configured to receive the first voltage signal via the data line when the control signal has the first voltage level; and
an eighth output terminal of the register electrically connected to the first voltage input of the multiple IAI devices, the first voltage signal appearing at the eighth output terminal when the control signal has the second voltage level.
